(19) United States
(12) Patent Application Publication
(10) Pub. No.: US 2026/0109820 A1
(43) Pub. Date: Apr. 23, 2026

(54) ADDITIVE MANUFACTURING METHOD FOR PRODUCING A SILICONE ELASTOMER ARTICLE

(71) Applicant: Elkem Silicones France SAS, Lyon (FR)

(72) Inventors: Jean-Marc FRANCES, MEYZIEU (FR); Christian MALIVERNEY, Saint Julien sur Bibost (FR); Perrine THEIL, St Pierre de Chandieu (FR)

(21) Appl. No.: 19/111,484

(22) PCT Filed: Sep. 15, 2023
(86) PCT No.: PCT/FR2023/000148

§ 371 Date: Mar. 13, 2025

(30) Foreign Application Priority Data
Sep. 15, 2022 (FR) FR2209269

(51) Int. Cl. C08G 77/395; B29C 64/124; B29K 83/00; B33Y 10/00; B33Y 70/00

(52) U.S. Cl. CPC C08G 77/395; B33Y 70/00; B29C 64/124; B29K 2083/005; B33Y 10/00

(57) ABSTRACT

The invention relates to an additive manufacturing method for producing a silicone elastomer article, the method comprising the following steps: i) providing a photocrosslinkable silicone composition X and an irradiation source, said photocrosslinkable silicone composition X comprising: a) at least one organopolysiloxane A including at least one (meth)acrylate group, and b) at least one radical photoinitiator B as defined in the present invention; ii) selectively irradiating at least a portion of the photocrosslinkable silicone composition X by means of the irradiation source to form a portion of the silicone elastomer article; and iii) repeating step ii) enough times to produce the silicone elastomer article.

### TECHNICAL FIELD

The present invention relates to an additive manufacturing method for producing an article by 3D printing from a photocrosslinkable composition X comprising at least one organopolysiloxane and at least one type I photoinitiator. In particular, this method makes it possible to produce an article by 3D printing from a photocrosslinkable composition X comprising at least one organopolysiloxane (meth)acrylate and a photoinitiator as defined in the present invention.

### TECHNOLOGICAL BACKGROUND

Nowadays, additive manufacture is very dynamic and has phenomenal growth potential due to its emergence and the many applications of the articles thus obtained.

More recently, 3D techniques have been developed with improved printing resolution, relatively high printing speed and flexibility in the modeling of parts, while at the same time having a low production cost.

A key element in the progress made in this technological field has been the development of novel photoinitiators or novel photoinitiator systems.

The design of these novel photoinitiators allows a reduction in the time required for additive manufacture of the part, but also, by virtue of their properties, makes it possible to work at lower energy levels and to obtain more complex products.

In the field of radical polymerization of acrylic silicone compositions, the photoinitiator molecules commonly used are “type I” photoinitiators. Under irradiation, these molecules split and produce free radicals. These radicals initiate the polymerization reaction that leads to the curing of the compositions. Extensive efforts have been made to ensure that type I photoinitiators have features that allow them to be used in acrylic silicone formulations to obtain release coatings. Throughout the patent application, the term “type I photoinitiators” means compounds that are capable of generating polymerization-initiating free radicals under irradiation by intramolecular homolytic fragmentation.

Type I photoinitiators are commonly used, but they may have drawbacks. In particular, the solubility of these photoinitiators in silicone compositions is not always optimal. Furthermore, photoinitiators and their degradation products, such as benzaldehyde, include health risks and may have an unpleasant odor.

Specifically, the toxicity of commonly used type I photoinitiators such as TPO-L (CAS 84434-11-7) could lead to their prohibition in the next few years in the food and healthcare industries.

Furthermore, in addition to its toxicity to humans, TPO-L is classified as ecotoxic by the European Chemicals Agency (ECHA).

In addition to these toxic properties, in the presence of at least 10% of fillers such as silica or other fillers with hydroxyl groups, the viscosity of TPO-L increases exponentially. This high viscosity makes the additive manufacturing method complex or even impossible.

The use of these fillers at high mass percentages notably affords silicone articles with improved and diversified mechanical properties, and thus greatly increases the applications of articles obtained using an additive manufacturing method.

It is thus essential to develop type I photoinitiators that are compatible with such fillers.

It is thus necessary to develop type I photoinitiators that can overcome these drawbacks.

In this context, the present invention is directed toward satisfying at least one of the following objects.

One of the essential objects of the invention is to provide a method for additive manufacture comprising a silicone composition that is photocrosslinkable by irradiation with a type I photoinitiator having satisfactory or even improved properties at a low active agent content.

Another essential object of the invention is to provide a method for additive manufacture comprising a silicone composition that is photocrosslinkable by irradiation with a type I photoinitiator, which does not have properties that are toxic to humans or to the environment.

Another essential object of the invention is to provide a method of additive manufacture comprising a silicone composition that is photocrosslinkable by irradiation with a type I photoinitiator having satisfactory photochemical properties and compatible with a filler content in the composition of greater than 20% relative to the total mass of the composition.

Another essential object of the invention is to provide a compound which can be used as a radical photoinitiator in additive manufacturing methods.

Another object of the present invention is that this photocrosslinkable silicone composition comprising a type I photoinitiator be able to be used to form release coatings.

Another object of the present patent application is to develop a type I photoinitiator that is suitable for a low or even very low energy additive manufacturing method for the wavelengths 385 nm and 405 nm, respectively.

Other objects will be seen on reading the following description of the invention.

Surprisingly, the Applicant has developed an additive manufacturing method in which the type I photoinitiator developed meets the above requirements.

To this end, the photoinitiators of the present invention are prepared via a preparation process analogous to those disclosed in patent applications WO 2014/053455 or WO 2018/050901.

### SUMMARY OF THE INVENTION

Thus, the invention relates to an additive manufacturing method for producing a silicone elastomer article, said method involving the following steps:
i) using a photocrosslinkable silicone composition X and an irradiation source, said photocrosslinkable silicone composition X comprising:
a) at least one organopolysiloxane A including at least one (meth)acrylate group
b) at least one radical photoinitiator B represented by the formula (I):

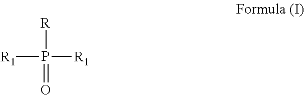

in which:
R represents a linear or branched C₁-C₅₀ alkylene or heteroalkylene group, preferably a linear or branched C₁-C₁₈ alkylene or heteroalkylene group, said alkylene and heteroalkylene groups comprising at least one siloxane function;
R₁ represents a group of formula (II):

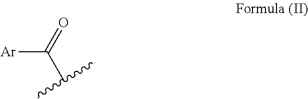

in which Ar represents an aryl group of 6 to 18 carbon atoms, which is unsubstituted or substituted with at least one of the following groups:
   an alkyl group of 1 to 6 carbon atoms,
   an alkenyl group of 2 to 4 carbon atoms,
   a heteroatom O, N or S,
   a halogen,
   an SiMe₃ group,
   a hydroxyl group (OH),
   a group (O-Alk) where Alk represents an alkyl group comprising from 1 to 15 carbon atoms, preferably from 1 to 12 carbon atoms, preferably from 1 to 10 carbon atoms, preferably from 1 to 5 carbon atoms, preferably CH₃ or C₂H₅;
R₂ represents:
   a group R₁
   an aryl group of 6 to 18 carbon atoms, which is unsubstituted or substituted with at least one of the following groups:
   an alkyl group of 1 to 6 carbon atoms,
an alkenyl group of 2 to 4 carbon atoms,
   a heteroatom O, N or S,
   a halogen,
   an SiMe₃ group,
   a hydroxyl group (OH),
   a group (O-Alk) where Alk represents an alkyl group comprising from 1 to 15 carbon atoms, preferably from 1 to 12 carbon atoms, preferably from 1 to 10 carbon atoms, preferably from 1 to 5 carbon atoms, preferably CH₃ or C₂H₅;
ii) selectively irradiating at least a portion of the photocrosslinkable silicone composition X by means of the irradiation source to form a part of the silicone elastomer article; and
iii) repeating step ii) a sufficient number of times to produce the silicone elastomer article.

The radical photoinitiator B defined according to the method of the present invention affords a photocrosslinkable silicone composition X which has good properties in terms of conversion and reaction kinetics.

This radical photoinitiator B has good solubility in silicones. It is thus possible to use the photoinitiator pure, by diluting it directly in the organopolysiloxane A.

Advantageously, the radical photoinitiator B may be dissolved in the organopolysiloxane A in less than 10 h, or in less than 5 h, or in less than 2 h. For example, this solubility may be determined by adding between 1 and 10 parts by mass of radical photoinitiator B to 100 parts by mass of organopolysiloxane A.

Furthermore, the use of the radical photoinitiator B according to the method of the present invention affords good crosslinking of the photocrosslinkable composition X and also the transparency of the silicone elastomer article obtained after crosslinking.

It should be noted that the degradation products of the radical photoinitiator B as defined in the present patent application have satisfactory initial toxicological data.

In the present patent application, the expression “silicone composition that is photocrosslinkable by irradiation” means a silicone composition comprising at least one organopolysiloxane that is capable of being cured by electron or photon irradiation. Among the electron irradiation means, mention may be made of exposure to an electron beam. Among the photon irradiation means, mention may be made of exposure to radiation with a wavelength of between 200 nm and 450 nm, notably UV radiation, or exposure to gamma rays.

The term “(meth)acrylate” means a methacrylate group or an acrylate group.

The term “alkyl” means a linear or branched alkyl group. The alkyl group preferably comprises 1 to 6 carbon atoms.

The term “alkylene” means a divalent, linear or branched alkyl group which may have unsaturated bonds. The alkylene group preferably comprises between 1 and 50 carbon atoms, preferentially between 1 and 10 carbon atoms and more preferentially between 1 and 6 carbon atoms.

The term “heteroalkylene” means a divalent, linear or branched heteroalkyl group which may have unsaturated bonds. The heteroalkylene group comprises between 1 and 50 carbon atoms, preferably between 1 and 18 carbon atoms, and between 1 and 6 heteroatoms selected from the group consisting of O, N and S, in which N and S may optionally be oxidized. The heteroatoms may be placed at any position in the heteroalkyl group, intersecting the chain or at any position in the chain (within or at an end of this chain).

Preferably, the “heteroalkylene” group as defined in the present invention comprises at least one ester function in its carbon-based chain.

In the present patent application, the “shear rate” measures the shear applied within the fluid. Thus, cone-plate viscometers allow the viscosity of a sample to be proportionally deduced from the angular speed of rotation in the sample (proportional to the shear rate). Unless otherwise indicated, all the viscosities under consideration in the present patent application correspond to a viscosity value measured at 25° C. according to the standard ASTM D4287. In the present patent application, all the percentages are indicated as mass percentages, unless otherwise mentioned.

### DETAILED DESCRIPTION OF THE INVENTION

In general, all additive manufacturing processes have a common starting point which is a computer data source or computer program that can describe an object. This computer data source or computer program may be based on a real or virtual object.

For example, a real object can be scanned using a 3D scanner and the data obtained can be used to generate the computer data source or computer program.

Alternatively, the computer data source or computer program may be designed from scratch.

The computer data source or computer program is generally converted into a file in stereolithography (STL) format, however, other file formats may be used. The file is generally read by 3D printing software which uses the file and, optionally, user input, to separate the object into hundreds or thousands of “layers”.

Usually, the 3D printing software transfers the instructions to the machine, for example in the form of G-code, which are read by the 3D printer which then manufactures the objects, usually layer by layer.

The method of additive manufacture via photopolymerization is a rapidly expanding technology. It is initiated by a photocrosslinkable liquid composition, deposited locally on a surface and then crosslinked. Alternatively, the liquid photocrosslinkable composition is placed in a tank and then selectively crosslinked.

Various additive manufacturing method techniques are known to those skilled in the art, such as printing by laser stereolithography (SLA), by digital light processing (DLP), by continuous liquid interface production (CLIP), by ink deposition or by extrusion.

Advantageously, in the context of the present application the additive manufacturing method is an additive manufacturing method by vat photopolymerization, in particular, by printing by laser stereolithography (SLA), by digital light processing (DLP), or by continuous liquid interface production (CLIP) or by using a process in which the radiation is transmitted through a liquid crystal display (LCD).

These technologies and the associated equipment are well known to those skilled in the art, who will be able to choose the appropriate technique and the corresponding 3D printer.

For example, these technologies and equipment are described in the following documents: WO 2015/197495, U.S. Pat. No. 5,236,637, WO 2016/181149 and WO 2014/126837.

The irradiation source may be any irradiation source that allows the photocrosslinkable silicone composition X to be photocrosslinked.

Advantageously, the irradiation source is a light source, preferably an ultraviolet (UV), visible or infrared (IR) light source. In general, UV light sources have a wavelength of between 200 and 400 nm, visible light sources of between 400 and 700 nm, and IR light sources have a wavelength greater than 700 nm, for example between 700 nm and 1 mm, or between 700 and 10 000 nm.

The light source may be a gas vapor lamp, diodes such as light emitting diodes or a laser.

Preferably, the irradiation source is chosen from UV lamps, UV lasers, visible lamps, visible lasers, IR lamps and IR lasers.

In a particular embodiment of the method, the irradiation source is a block of light emitting diodes (LEDs), preferably a block of light emitting diodes (LEDs) having a wavelength of 355, 365, 385 or 405 nm.

The power of the irradiation source may be at least 1, 10 or 50 mW/cm². It may be between 1 and 1000 mW/cm², preferably between 1 and 500 mW/cm², preferably between 1 and 200 mW/cm², and more preferentially between 1 and 50 mW/cm².

In a particular embodiment, the irradiation penetration depth (Dp) is less than 2000 μm for an irradiance of between 1 and 50 mW/cm² at 385 or 405 nm, preferably the penetration depth is between 100 and 1000 μm, and more preferentially between 100 and 500 μm.

A person skilled in the art will be able to adapt the photoinitiator content, the power of the irradiation source and the irradiation time to obtain the desired penetration depth suitable for the object.

In a preferred embodiment, the method does not use a dual cure type composition. In particular, the method does not use a composition that can be crosslinked by polyaddition.

In one embodiment, the method includes a cleaning step, for instance a solvent rinse or a post-treatment step such as exposure to an additional radiation source or exposure to heat for a given period of time.

In a particular embodiment, the method does not include a post-treatment step.

Preferably, the photocrosslinkable silicone composition X is used in a tank and the silicone elastomer article is produced on a plate, preferably a moving plate. The plate may be any type of plate.

Advantageously, the plate is a platform of a 3D printer, such as a moving platform, or a support for one or more layers of the photocrosslinkable silicone composition X initially printed to the desired geometry so that they can be detached and crosslinked under irradiation.

According to a first embodiment of the method, the additive manufacturing method is performed layer by layer, each layer representing a surface of the photocrosslinkable silicone composition X.

This first embodiment is particularly suitable for printing by laser stereolithography (SLA), and digital light processing (DLP).

In this first embodiment, the irradiation step ii) may involve the following sub-steps:
a. depositing a first layer of the photocrosslinkable silicone composition X on a plate;
b. selectively irradiating the surface of the photocrosslinkable silicone composition X with an irradiation source to form a crosslinked layer of the silicone elastomer article to be produced;
c. forming an additional layer of photocrosslinkable silicone composition X on the first crosslinked layer produced in step b); and
d. selectively irradiating the additional layer to form an additional crosslinked layer of the silicone elastomer article to be produced.

The plate onto which the layer of photocrosslinkable silicone composition X is deposited during step a) may be any type of plate.

Preferably, it is a moving plate.

Advantageously, the plate is a platform of a 3D printer, such as a moving platform. The support applied to the plate may also comprise the first layer or generally comprise several layers of the photocrosslinkable silicone composition X which are deposited and irradiated selectively.

Preferably, during step d), the additional layer that is formed adheres to the first crosslinked layer of the silicone elastomer article formed in step b).

Advantageously, the thickness of a layer of photocrosslinkable silicone composition X is between 0.1 and 500 μm, preferably between 5 and 400 μm, preferentially between 10 and 300 μm, and more preferentially between 10 and 100 μm.

In a particular embodiment, the irradiation time of the layer of photocrosslinkable silicone composition X is at least 0.001 second.

Preferably, the irradiation time is between 0.001 second and 10 minutes, preferably between 0.001 second and 5 minutes and more preferentially between 0.01 second and 1 minute.

These various parameters may be adjusted as a function of the desired result.

The deposition of a layer of photocrosslinkable silicone composition X may be performed by moving the support, or using a knife or doctor blade, which deposits a new layer of photocrosslinkable silicone composition X.

Preferably, in the case where the irradiation source is a laser (SLA method, for example), the laser traces the surface of the layer of the silicone elastomer article to be produced, so as to have selective irradiation, and in the case where the irradiation source is a block of light-emitting diodes (DLP method, for example), a single image of the crosslinked layer of the object to be printed is projected onto the entire surface of the photocrosslinkable composition X.

Two variants are possible in this first embodiment: additive manufacture may be performed by top irradiation or bottom irradiation. These two variants are described in U.S. Pat. No. 5,236,637.

In a first variant of this first embodiment, additive manufacture is performed from the top: the photocrosslinkable silicone composition X is contained in a tank and the irradiation source is focused on the surface of the photocrosslinkable silicone composition X. The layer which is irradiated is that between the plate and the surface of the photocrosslinkable silicone composition X.

In this first variant, the deposition of a layer of photocrosslinkable silicone composition X is performed by lowering the plate into the tank by a distance equal to the thickness of a layer. A knife or doctor blade can then sweep the surface of the photocrosslinkable silicone composition X, allowing it to be flattened.

In a second variant of this first embodiment, additive manufacture is from the bottom: the tank comprises a transparent bottom and a non-adhesive surface, and the irradiation source is focused on the transparent bottom of the tank. The layer that is irradiated is thus that between the bottom of the tank and the plate.

In this case, the deposition of a layer of photocrosslinkable silicone composition X is performed by raising the plate to allow the photocrosslinkable silicone composition X to be inserted between the bottom of the tank and the plate. The distance between the bottom of the tank and the plate corresponds to the thickness of a layer.

Advantageously, the additive manufacturing method is a digital light processing (DLP) in-tank photopolymerization additive manufacturing method, in which the additive manufacture is performed from the bottom: the deposition of a layer of photocrosslinkable silicone composition X is performed by raising the plate in the tank to allow the photocrosslinkable silicone composition X to be inserted between the bottom of the tank and the plate. The distance between the bottom of the tank and the plate corresponds to the thickness of a layer.

According to a second embodiment, the additive manufacturing method is performed continuously. This second embodiment is particularly suitable for the continuous liquid interface production (CLIP) described in WO 2014/126837. In this second embodiment, the irradiation step ii) may involve the following sub-steps, which take place simultaneously:
a. selectively irradiating at least a portion of the photocrosslinkable silicone composition X with an irradiation source to form a part of the silicone elastomer article on the plate; and
b. moving the plate and the part of the silicone elastomer article formed in step a) away from the irradiation source along the irradiation axis.

Advantageously, in step a), the part of the silicone elastomer article is formed on a plate and during step b), it is the plate which is moved simultaneously.

Preferably, in this second embodiment, additive manufacture is performed by irradiation from the bottom: the tank comprises a transparent bottom and the irradiation source is focused on the transparent bottom of the tank.

By means of an oxygen-permeable membrane, photopolymerization only takes place at the interface between the photocrosslinkable silicone composition X and the plate; the photocrosslinkable composition X between the bottom of the tank and the interface does not photopolymerize.

Thus, it is possible to maintain a continuous liquid interface in which the silicone elastomer article is formed by irradiating the photocrosslinkable composition X and simultaneously moving the part of the silicone elastomer article formed on the plate out of the tank.

Once the silicone elastomer article has been obtained, it can be rinsed so as to remove the photocrosslinkable silicone composition X that has not crosslinked.

Once the silicone elastomer article has been obtained, it is also possible to perform additional steps to improve the surface quality of the article. The use and application of coatings such as top coats in the final layer notably allows the surface quality of the article to be improved.

Spraying or coating the silicone elastomer article with an LSR or RTV silicone composition which can be crosslinked by heating or UV radiation may also be used to have a smooth appearance. It is also possible to perform a surface treatment on the article obtained using a laser.

For medical applications, it is possible to sterilize the silicone elastomer article obtained. Sterilization of the article may be performed by heating, for example to a temperature above 100° C., either in a dry atmosphere or in an autoclave with steam. Sterilization may also be performed using gamma rays, ethylene oxide or electron beams.

The invention also relates to a silicone elastomer article obtained via the method described in the present patent application.

The silicone elastomer article obtained may be any article of simple or complex geometry. It may, for example, be silicone molds, masks, pipes, anatomical models (functional or non-functional) such as a heart, a kidney, a prostate, models for surgeons or for teaching, orthoses, prostheses, such as dental prostheses, aligners, mouth guards, or implants of different classes, such as long-term implants, hearing aids, stents, laryngeal implants, etc.

The silicone elastomer article obtained may also be a jack for robotics, a seal, a mechanical component for motor vehicles or aeronautics, a component for electronic apparatus, a piece for encapsulating components, a vibration insulator, an impact insulator or a sound insulator.

### Photocrosslinkable Composition X:

According to one embodiment, the photocrosslinkable silicone composition X has a dynamic viscosity of between 0.01 and 20 Pa·s at a shear rate of 10 s⁻¹, preferably between 0.1 and 10 Pa·s, more preferentially between 0.1 and 5 Pa·s at a shear rate of 10 s⁻¹.

In the present patent application, according to the method of the invention, the photocrosslinkable silicone compositions X comprise at least one organopolysiloxane A.

Preferably, according to the method of the invention, the photocrosslinkable silicone compositions X comprise at least one organopolysiloxane A including at least one (meth)acrylate group, preferably at least two (meth)acrylate groups.

As representative of the (meth)acrylate functions borne by the silicone and particularly suitable for the invention, mention may be made more particularly of acrylate derivatives, methacrylates, (meth)acrylate ethers and (meth)acrylate esters linked to the polysiloxane chain by an Si—C bond.

According to one embodiment, the organopolysiloxane A comprises:
a) at least one unit of formula (III) below:

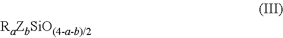

in which formula:
   the symbols R, which may be identical or different, each represent a linear or branched C₁-C₁₈ alkyl group, a C₆-C₁₂ aryl or aralkyl group, it being possible for said alkyl and aryl groups to be optionally substituted, preferably with halogen atoms, or a group —OR⁵ with R⁵ being a hydrogen atom or a hydrocarbon-based group comprising from 1 to 10 carbon atoms,
   the symbols Z are monovalent groups of formula -y-(Y′) n in which:
   y represents a C₁-C₁₈ polyvalent alkylene or heteroalkylene group, said alkylene and heteroalkylene groups possibly being linear or branched, and possibly being interrupted with one or more cycloalkylene groups, and possibly being extended with divalent C₁-C₄ oxyalkylene or polyoxyalkylene radicals, said alkylene, heteroalkylene, oxyalkylene and polyoxyalkylene groups possibly being substituted with one or more hydroxyl groups,
   Y′ represents a monovalent alkenylcarbonyloxy group, and
   n is equal to 1, 2 or 3, and
   a is an integer equal to 0, 1 or 2, b is an integer equal to 1 or 2 and the sum a+b=1, 2 or 3; and
b) optionally units of formula (IV) below:

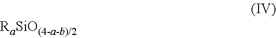

in which formula:
   the symbols R are as defined above in formula (III), and
   a is an integer equal to 0, 1, 2 or 3.

In the above formulae (III) and (IV), the symbols R, which may be identical or different, each represent a linear or branched C₁-C₁₈ alkyl group or a C₆-C₁₂ aryl or aralkyl group. Preferably, the symbol R represents a monovalent group chosen from the group consisting of methyl, ethyl, propyl, 3,3,3-trifluoropropyl, xylyl, tolyl and phenyl, and preferentially the symbol R represents methyl.

The organopolysiloxane A may have a linear, branched, cyclic or network structure. Preferably, the organopolysiloxane A has a linear structure. In the case of linear organopolysiloxanes, these may essentially consist of:
“D” siloxyl units chosen from units of formulae R₂SiO_{2/2}, RZSiO_{2/2} and Z₂SiO_{2/2};
“M” siloxyl units chosen from units of formulae R₃SiO_{1/2}, R₂ZSiO_{1/2}, RZ₂SiO_{1/2} and Z₃SiO_{1/2}, and
the symbols R and Z are as defined above in formula (III).

According to one embodiment, in the above formula (III), among the abovementioned alkenylcarbonyloxy groups Y′, mention may be made of acryloxy [CH₂═CH—CO—O-] and the methacryloxy group: [CH₂═C(CH₃)—CO—O—]. Advantageously, the organopolysiloxane A comprises at least two alkenylcarbonyloxy groups Y′, preferably at least three alkenylcarbonyloxy groups Y′.

By way of illustration of the symbol y in the units of formula (III), mention will be made of the groups:
—CH₂—;
—(CH₂)₂—;
—(CH₂)₃—;
—CH₂—CH(CH₃)—CH₂—;
—(CH₂)₃—NR′—CH₂—CH₂—; with R′ being a C₁-C₆ alkyl group
—(CH₂)₃—OCH₂—;
—(CH₂)₃—[O—CH₂—CH(CH₃)—]ₙ—; with n=1 to 25
—(CH₂)₃—O—CH₂—CH(OH)(—CH₂—);
—(CH₂)₃—O—CH₂—C(CH₂—CH₃)[—(CH₂—)]₂;
—(CH₂)₃—O—CH₂—C[—(CH₂)—]₃ and
—(CH₂)₂—C₆H₉ (OH)—.

Preferably, the organopolysiloxane A corresponds to formula (V) below:

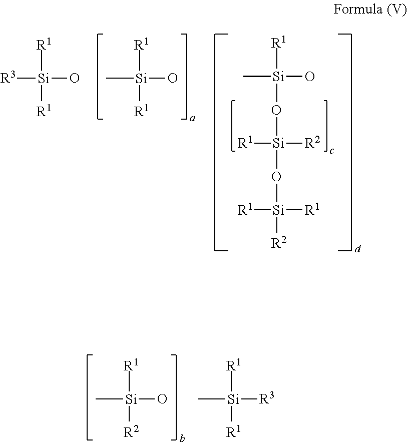

in which formula:
   the symbols R¹, which may be identical or different, each represent a linear or branched C₁-C₁₈ alkyl group, a C₆-C₁₂ aryl or aralkyl group, it being possible for said alkyl and aryl groups to be optionally substituted, preferably with halogen atoms, or a group —OR⁵ with R⁵ being a hydrogen atom or a hydrocarbon-based group comprising from 1 to 10 carbon atoms,
   the symbols R² and R³, which may be identical or different, each represent either a group R¹ or a monovalent group of formula Z=-y-(Y″)n in which:
   y represents a polyvalent C₁-C₁₈ alkylene or heteroalkylene group, said alkylene and heteroalkylene groups possibly being linear or branched, and possibly being interrupted with one or more cycloalkylene groups, and possibly being extended with divalent C₁-C₄ oxyalkylene or polyoxyalkylene radicals, said alkylene, heteroalkylene, oxyalkylene and polyoxyalkylene groups possibly being substituted with one or more hydroxyl groups,
   Y′ represents a monovalent alkenylcarbonyloxy group,
   n is equal to 1, 2 or 3, and
   with a=0 to 1000, b=0 to 500, c=0 to 500, d=0 to 500 and a+b+c+d=0 to 2500, preferably a=0 to 500 and a+b+c+d=0 to 500,
   on condition that at least one symbol R² or R³ represents the monovalent group of formula Z, preferably at least two symbols R² or R³ represent a monovalent group of formula Z.

According to a preferred embodiment, in the above formula (V):
c=0, d=0, a=1 to 1000, b=1 to 250, the symbol R² represents the monovalent group of formula Z and the symbols R¹ and R³ have the same meaning as above.

In an even more preferential manner, in the above formula (V):
c=0, d=0, a=1 to 500, b=2 to 100, the symbol R² represents the monovalent group of formula Z and the symbols R¹ and R³ have the same meaning as above.

According to one embodiment, the organopolysiloxane A according to the invention corresponds to one of the formulae (VIa), (VIb), (VIc) or (VId) below:

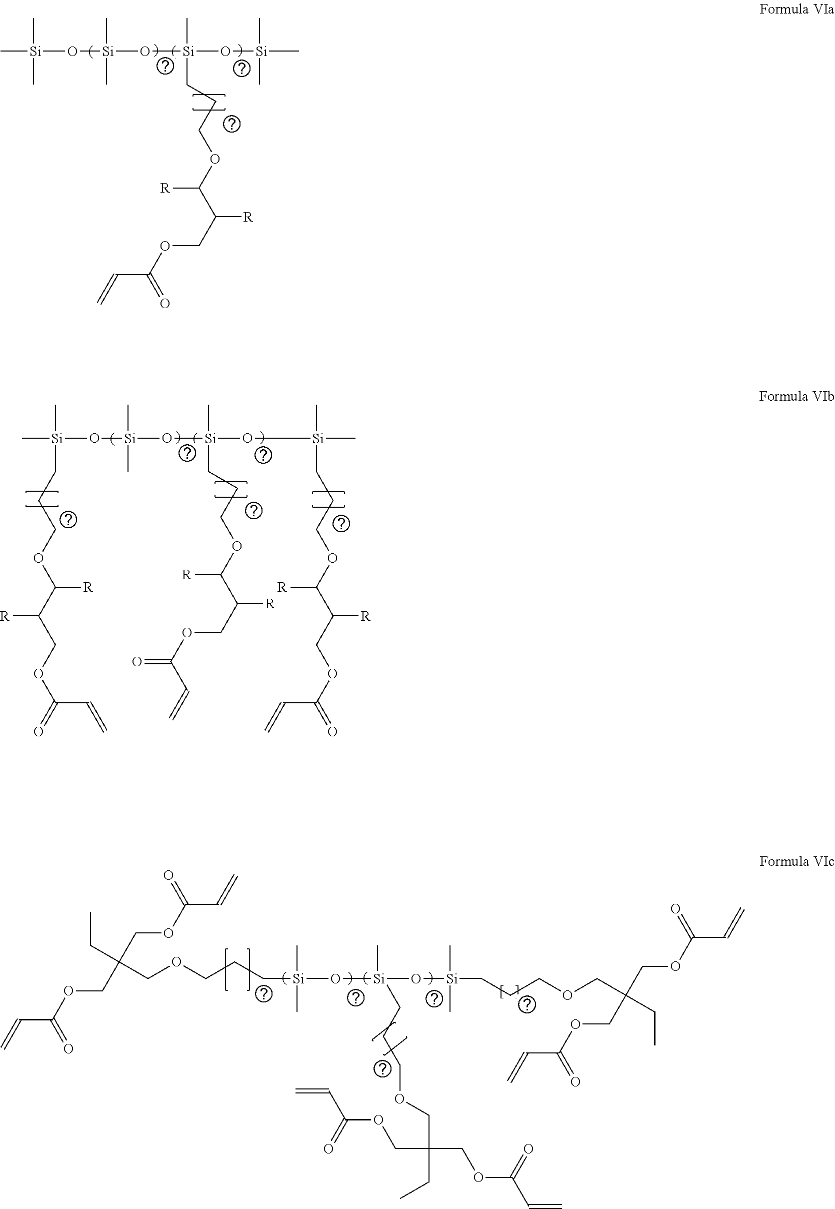

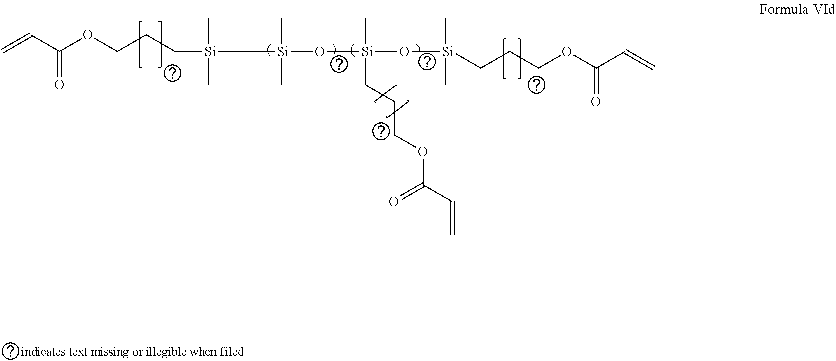

in which:
R, which may be identical or different, represents a hydrogen atom or a hydroxyl group;
   x₁ is an integer between 1 and 1000; preferably x₁ is between 1 and 500;
   n₁ is an integer between 1 and 100, preferably n₁ is between 2 and 50;
   x₂ is an integer between 1 and 1000, preferably x₂ is between 1 and 500;
   n₂ is an integer between 0 and 100, preferably n₂ is between 0 and 50;
   x₃ is an integer between 1 and 1000, preferably x₃ is between 1 and 500;
   n₃ is an integer between 0 and 100, preferably n₃ is between 0 and 50;
   x₄ is an integer between 1 and 1000, preferably x₄ is between 1 and 500;
   n₄ is an integer between 0 and 100, preferably n₄ is between 0 and 50;
   m₁, m₂, m₃ and m₄ are integers between 1 and 8.

According to one embodiment, the organopolysiloxane A according to the invention corresponds to one of the formulae (VIIa), (VIIb), (VIIc) or (VIId) below:

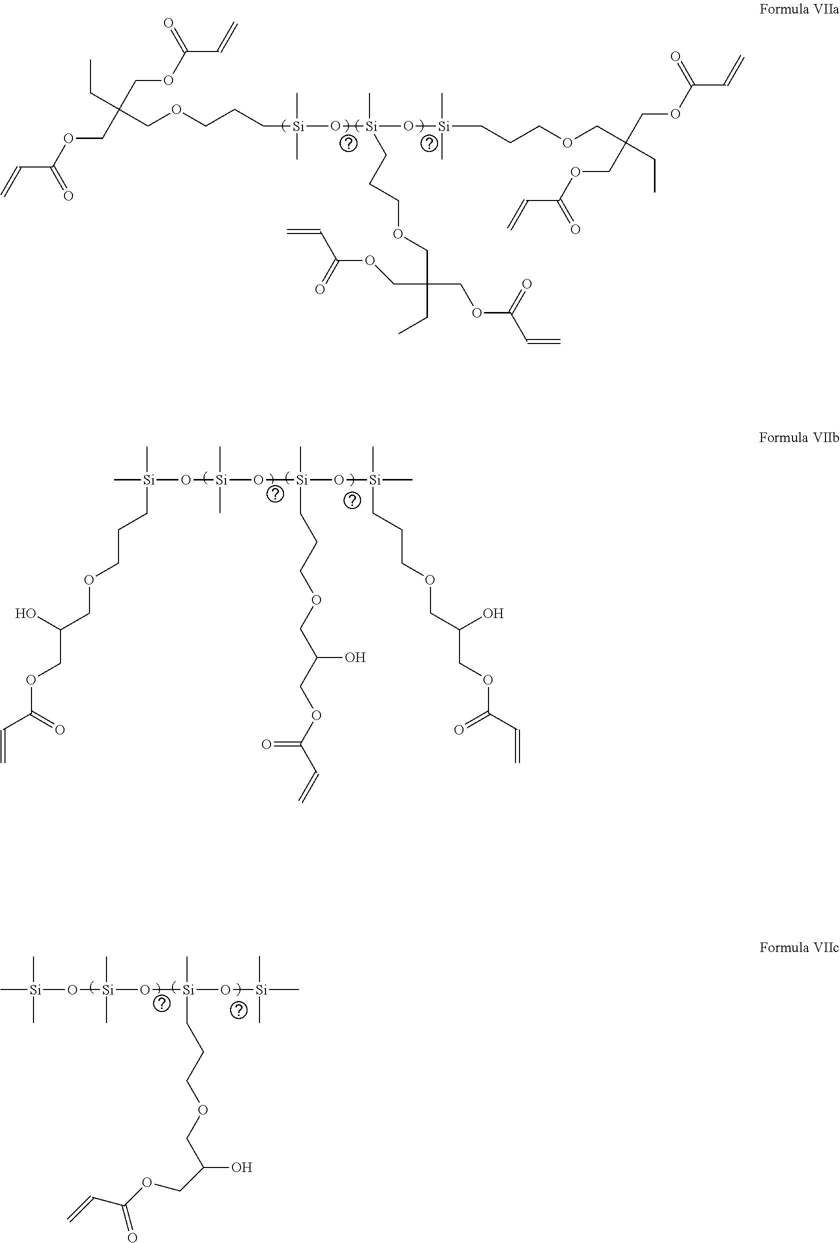

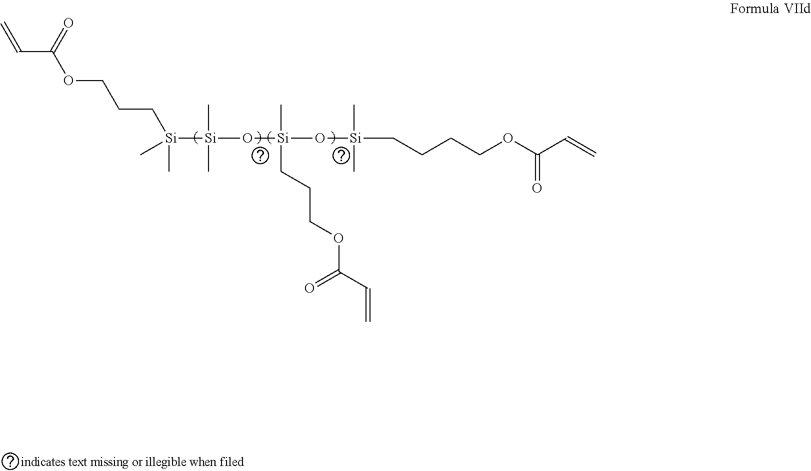

in which:
   x₁ is an integer between 1 and 1000; preferably x₁ is between 1 and 500;
   n₁ is an integer between 0 and 100, preferably n₁ is between 0 and 50;
   x₂ is an integer between 1 and 1000, preferably x₂ is between 1 and 500;
   n₂ is an integer between 0 and 100, preferably n₂ is between 0 and 50;
   x₃ is an integer between 1 and 1000, preferably x₃ is between 1 and 500;
   n₃ is an integer between 1 and 100, preferably n₃ is between 1 and 50;
   x₄ is an integer between 1 and 500, preferably x₄ is between 1 and 200;
   n₄ is an integer between 0 and 100, preferably n₄ is between 0 and 50.

According to the method of the invention, the photocrosslinkable silicone composition X may comprise between 10% and 99.9% by mass of organopolysiloxane A, relative to the total mass of the photocrosslinkable silicone composition X.

Preferably, the photocrosslinkable silicone composition X may comprise between 10% and 99.5% by mass of organopolysiloxane A, relative to the total mass of the photocrosslinkable silicone composition X.

Needless to say, according to the variants, the organopolysiloxane A may be a mixture of compounds corresponding to the definition of the organopolysiloxane A.

For the purposes of the present invention, the radical photoinitiator B is represented by the formula (I):

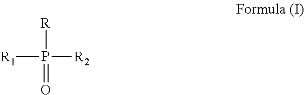

in which:
R represents a linear or branched C₁-C₅₀ alkylene or heteroalkylene group, preferably a linear or branched C₁-C₁₈ alkylene or heteroalkylene group, said alkylene and heteroalkylene groups comprising at least one siloxane function;
R₁ represents a group of formula (II):

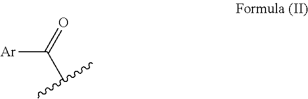

in which Ar represents an aryl group of 6 to 18 carbon atoms, which is unsubstituted or substituted with at least one of the following groups:
   an alkyl group of 1 to 6 carbon atoms,
   an alkenyl group of 2 to 4 carbon atoms,
   a heteroatom O, N or S,
   a halogen,
   an SiMe₃ group,
   a hydroxyl group (OH),
   a group (O-Alk) where Alk represents an alkyl group comprising from 1 to 15 carbon atoms, preferably from 1 to 12 carbon atoms, preferably from 1 to 10 carbon atoms, preferably from 1 to 5 carbon atoms, preferably CH₃ or C₂H₅;
R₂ represents:
   a group R₁
   an aryl group of 6 to 18 carbon atoms, which is unsubstituted or substituted with at least one of the following groups:
   an alkyl group of 1 to 6 carbon atoms,
   an alkenyl group of 2 to 4 carbon atoms,
   a heteroatom O, N or S,
   a halogen,
   an SiMe₃ group,
   a hydroxyl group (OH),
   a group (O-Alk) where Alk represents an alkyl group comprising from 1 to 15 carbon atoms, preferably from 1 to 12 carbon atoms, preferably from 1 to 10 carbon atoms, preferably from 1 to 5 carbon atoms, preferably CH₃ or C₂H₅.

According to one embodiment of the method of the present invention, the radical photoinitiator B is a compound of formula (VIII):

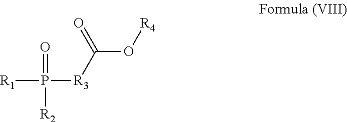

in which:
R₁ and R₂ represent the groups as defined previously;
R₃ represents a linear or branched C₁-C₆ alkylene or heteroalkylene group;
R₄ represents a linear or branched C₁-C₅₀ alkylene or heteroalkylene group, preferably a linear or branched C₁-C₁₈ alkylene or heteroalkylene group, said R₄ comprising at least one siloxane function.

Preferably, the radical photoinitiator B is a compound of formula (VIIIa):

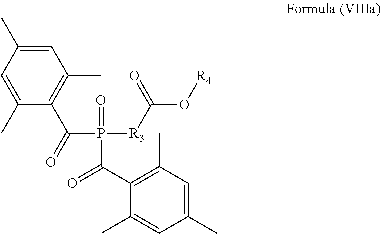

in which R₃ and R₄ represent groups as defined previously.

Alternatively, the radical photoinitiator B is a compound of formula (VIIIb):

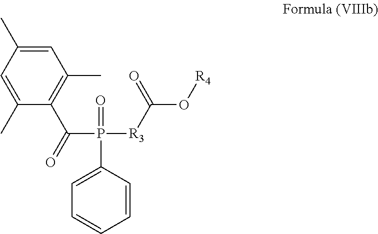

in which R₃ and R₄ represent groups as defined previously.

According to one embodiment of the invention, the radical photoinitiator B is an organopolysiloxane comprising:
a) at least one unit R_{c}Z_{d}SiO_{(4-c-d)/2} (IX)
in which formula (IX):
   the symbols R, which may be identical or different, each represent a linear or branched C₁-C₁₈ alkyl group, a C₆-C₁₂ aryl or aralkyl group, it being possible for said alkyl and aryl groups to be optionally substituted, preferably with halogen atoms, or a group —OR⁵ with R⁵ being a hydrogen atom or a hydrocarbon-based group comprising from 1 to 10 carbon atoms,
   the symbols Z are monovalent groups of formula -y-(Y′) n in which:
   y represents a C₁-C₅₀, preferably C₁-C₁₈, polyvalent alkylene or heteroalkylene group, said alkylene and heteroalkylene groups possibly being linear or branched, and possibly being interrupted with one or more heteroatoms selected from the group consisting of O, N and S, where N and S may optionally be oxidized; said alkylene or heteroalkylene groups possibly being substituted with one or more hydroxyl groups,
   Y′ represents a group of Formula (X):

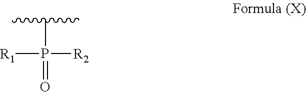

in which:
R₁ represents a group of formula (XI):

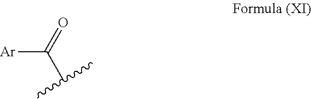

in which Ar represents an aryl group of 6 to 18 carbon atoms, which is unsubstituted or substituted with at least one of the following groups:
   an alkyl group of 1 to 6 carbon atoms,
   an alkenyl group of 2 to 4 carbon atoms,
   a heteroatom O, N or S,
   a halogen,
   an SiMe₃ group,
   a hydroxyl group (OH),
   a group (O-Alk) where Alk represents an alkyl group comprising from 1 to 15 carbon atoms, preferably from 1 to 12 carbon atoms, preferably from 1 to 10 carbon atoms, preferably from 1 to 5 carbon atoms, preferably CH₃ or C₂H₅;
R₂ represents:
   a group R₁
   an aryl group of 6 to 18 carbon atoms, which is unsubstituted or substituted with at least one of the following groups:
   an alkyl group of 1 to 6 carbon atoms,
   an alkenyl group of 2 to 4 carbon atoms,
   a heteroatom O, N or S,
   a halogen,
   an SiMe₃ group,
   a hydroxyl group (OH),
   a group (O-Alk) where Alk represents an alkyl group comprising from 1 to 15 carbon atoms, preferably from 1 to 12 carbon atoms, preferably from 1 to 10 carbon atoms, preferably from 1 to 5 carbon atoms, preferably CH₃ or C₂H₅.
   n is equal to 1 or 2;
   c is an integer equal to 0, 1 or 2, d is an integer equal to 1 or 2 and the sum c+d=1, 2 or 3; and
b) MDT units, of formula (XII) below:

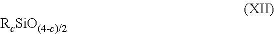

in which formula:
   the symbols R are as defined above in formula (IX), and
   c is an integer equal to 0, 1, 2 or 3.

In the above formulae (IX) and (XII), the symbols R, which may be identical or different, each represent a linear or branched C₁-C₁₈ alkyl group or a C₆-C₁₂ aryl or aralkyl group. Preferably, the symbol R represents a monovalent group chosen from the group consisting of methyl, ethyl, propyl, 3,3,3-trifluoropropyl, xylyl, tolyl and phenyl, and preferentially the symbol R represents methyl.

The radical photoinitiator B of the present invention may have a linear, branched, cyclic or network structure. Preferably, the radical photoinitiator B has a linear structure. In the case of linear organopolysiloxanes, these may essentially consist of:
“D” siloxyl units chosen from units of formulae R₂SiO_{2/2}, RZSiO_{2/2} and Z₂SiO_{2/2};
“M” siloxyl units chosen from units of formulae R₃SiO_{1/2}, R₂ZSiO_{1/2}, RZ₂SiO_{1/2} and Z₃SiO_{1/2}, and
the symbols R and Z are as defined above in formula (IX).

In the present invention:
an “M” siloxyl unit represents a siloxyl unit of formula Y₃SiO_{1/2},
a “D” siloxyl unit represents a siloxyl unit of formula Y₂SiO_{2/2},
a “T” siloxyl unit represents a siloxyl unit of formula YSiO_{3/2},
a “Q” siloxyl unit represents a siloxyl unit of formula SiO_{4/2}, the symbols Y being an identical or different group R.

The radical photoinitiator B as defined in formulae (IX) and (XII) may optionally comprise T and Q units.

According to one embodiment of the method of the present invention, the radical photoinitiator B is a compound of formula (XIII):

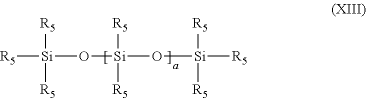

in which:
R₅, which may be identical or different, represents:
   an alkyl group comprising from 1 to 15 carbon atoms, preferably from 1 to 12 carbon atoms, preferably from 1 to 10 carbon atoms, preferably from 1 to 5 carbon atoms, preferably methyl,
   an aryl group comprising from 6 to 10 carbon atoms, preferably phenyl,
   an alkenyl group comprising from 2 to 6 carbon atoms, preferably vinyl,
   an acrylate or meth (acrylate) group,
   a hydroxyl group (OH),
   a group (O-Alk) where Alk represents an alkyl group comprising from 1 to 15 carbon atoms, preferably from 1 to 12 carbon atoms, preferably from 1 to 10 carbon atoms, preferably from 1 to 5 carbon atoms, preferably CH₃ or C₂H₅,
   a group (O-Alk)ₓ with Alk representing an alkyl group comprising from 1 to 15 carbon atoms, preferably from 1 to 12 carbon atoms, preferably from 1 to 10 carbon atoms, preferably from 1 to 5 carbon atoms, preferably methyl, and x represents an integer between 2 and 200,
   a linear or branched alkyl group comprising from 1 to 10 carbon atoms, preferably from 1 to 5 carbon atoms, substituted with at least one fluorine atom, for example from 1 to 10 fluorine atoms, for example (C₁-C₅)alkyl-CF₃, the alkyl being linear or branched,
   a hydrogen atom,
   a group of formula (XIV):

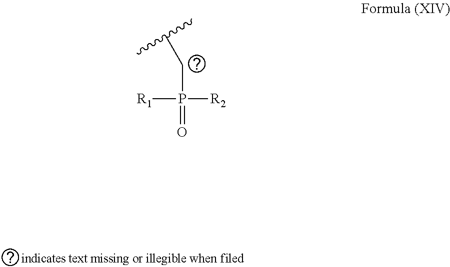

in which R₁ and R₂ represent groups as defined previously;
R₆ represents a linear or branched C₁-C₅₀ alkylene or heteroalkylene group, preferably a linear or branched C₁-C₁₈ alkylene or heteroalkylene group;
a represents an integer between 0 and 100;
said method being characterized in that at least one group R₅ is represented by the group of formula (XIV).

Preferably, the radical photoinitiator B is characterized in that the group of formula (XIV) is represented by the compound of formula (XIIIa):

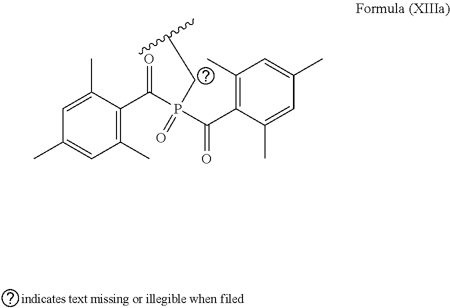

in which R₆ is as defined previously.

Alternatively, the radical photoinitiator B is characterized in that the group of formula (XIV) is represented by the compound of formula (XIIIb):

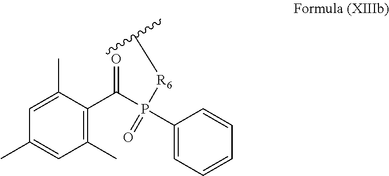

in which R₆ is as defined previously.

According to one embodiment of the method of the present invention, the radical photoinitiator B is a compound of formula (XV):

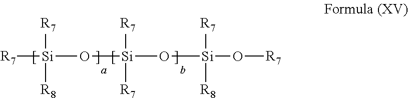

in which:
R₇, which may be identical or different, represents:
   an alkyl group comprising from 1 to 15 carbon atoms, preferably from 1 to 12 carbon atoms, preferably from 1 to 10 carbon atoms, preferably from 1 to 5 carbon atoms, preferably methyl,
   an aryl group comprising from 6 to 10 carbon atoms, preferably phenyl;
   an alkenyl group comprising from 2 to 6 carbon atoms, preferably vinyl;
   a hydroxyl group (OH),
   a group (O-Alk) where Alk represents an alkyl group comprising from 1 to 15 carbon atoms, preferably from 1 to 12 carbon atoms, preferably from 1 to 10 carbon atoms, preferably from 1 to 5 carbon atoms, preferably CH₃ or C₂H₅,
   a group (O-Alk)ₓ with Alk representing an alkyl group comprising from 1 to 15 carbon atoms, preferably from 1 to 12 carbon atoms, preferably from 1 to 10 carbon atoms, preferably from 1 to 5 carbon atoms, preferably methyl, and x represents an integer between 2 and 200,
   an acrylate or meth (acrylate) group,
   a linear or branched alkyl group comprising from 1 to 10 carbon atoms, preferably from 1 to 5 carbon atoms, substituted with at least one fluorine atom, for example from 1 to 10 fluorine atoms, for example (C₁-C₅)alkyl-CF₃, the alkyl being linear or branched,
   a hydrogen atom;
R₈ represents a group as defined for R₇ or a group of formula (XVI):

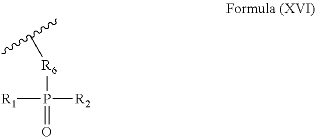

in which R₁ and R₂ represent groups as defined previously;
R₆ represents a linear or branched C₁-C₅₀ alkylene or heteroalkylene group;
preferably a linear or branched C₁-C₁₈ alkylene or heteroalkylene group;
a represents an integer between 0 and 10;
b represents an integer between 1 and 100;
said method being characterized in that at least one group R₈ is represented by the group of formula (XVI).

Preferably, the group of formula (XVI), as defined above, has the formula:

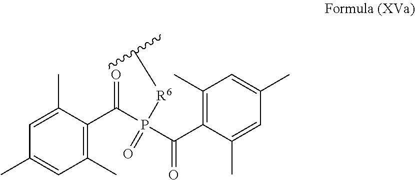

in which R₆ is as defined previously.

Alternatively, the group of formula (XVI), as defined above, has the formula:

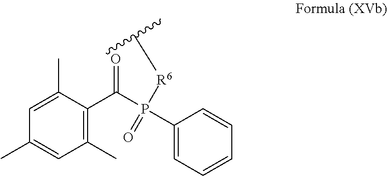

in which R₆ is as defined previously.

In a particular embodiment of the invention, the radical photoinitiator B is a compound of formula (XV) as defined previously in which two consecutive siloxane units may be interrupted with an O—Si(CH₃)₂—CH₂—CH₂—Si(CH₃)₂ unit.

In one embodiment, the method of the invention is characterized in that the radical photoinitiator B is a compound of formula (XVII):

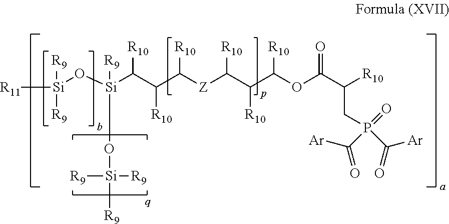

in which:
R₉, which may be identical or different, represents:
   an alkyl group comprising from 1 to 15 carbon atoms, preferably from 1 to 12 carbon atoms, preferably from 1 to 10 carbon atoms, preferably from 1 to 5 carbon atoms, preferably methyl,
   an aryl group comprising from 6 to 10 carbon atoms, preferably phenyl;
   an alkenyl group comprising from 2 to 6 carbon atoms, preferably vinyl;
   a hydroxyl group (OH),
   a group (O-Alk) where Alk represents an alkyl group comprising from 1 to 15 carbon atoms, preferably from 1 to 12 carbon atoms, preferably from 1 to 10 carbon atoms, preferably from 1 to 5 carbon atoms, preferably CH₃ or C₂H₅,
   a group (O-Alk)ₓ with Alk representing an alkyl group comprising from 1 to 15 carbon atoms, preferably from 1 to 12 carbon atoms, preferably from 1 to 10 carbon atoms, preferably from 1 to 5 carbon atoms, preferably methyl, and x represents an integer between 2 and 200,
   an acrylate or meth (acrylate) group,
   a linear or branched alkyl group comprising from 1 to 10 carbon atoms, preferably from 1 to 5 carbon atoms, substituted with at least one fluorine atom, for example 1 to 10 fluorine atoms, for example (C₁-C₅)alkyl-CF₃, the alkyl being linear or branched,
   an amino group chosen from (Alk)-NH₂ or (Alk)-NH-(Alk)-NH₂, with Alk representing an alkyl comprising from 1 to 5 carbon atoms,
   a carbonyl or carboxyl group,
   a hydrogen atom,
   a group of formula (XVIII):

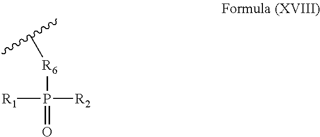

in which R₁ and R₂ represent groups as defined previously;
R₆ represents a linear or branched C₁-C₅₀ alkylene or heteroalkylene group;
preferably a linear or branched C₁-C₁₈ alkylene or heteroalkylene group;
R₁₀, which may be identical or different, represents:
   an alkyl group comprising from 1 to 15 carbon atoms, preferably from 1 to 12 carbon atoms, preferably from 1 to 10 carbon atoms, preferably from 1 to 5 carbon atoms, preferably methyl,
   an aryl group comprising from 6 to 10 carbon atoms, preferably phenyl;
   an alkenyl group comprising from 2 to 6 carbon atoms, preferably vinyl;
   a hydroxyl group (OH),
   a group (O-Alk) where Alk represents an alkyl group comprising from 1 to 15 carbon atoms, preferably from 1 to 12 carbon atoms, preferably from 1 to 10 carbon atoms, preferably from 1 to 5 carbon atoms, preferably CH₃ or C₂H₅,
   a group (O-Alk)ₓ with Alk representing an alkyl group comprising from 1 to 15 carbon atoms, preferably from 1 to 12 carbon atoms, preferably from 1 to 10 carbon atoms, preferably from 1 to 5 carbon atoms, preferably methyl, and x represents an integer between 2 and 200,
   an acrylate or meth (acrylate) group,
   a linear or branched alkyl group comprising from 1 to 10 carbon atoms, preferably from 1 to 5 carbon atoms, substituted with at least one fluorine atom, for example 1 to 10 fluorine atoms, for example (C₁-C₅)alkyl-CF₃, the alkyl being linear or branched,
   an amino group chosen from (Alk)-NH₂ or (Alk)-NH-(Alk)-NH₂, with Alk representing an alkyl comprising from 1 to 5 carbon atoms,
   a carbonyl or carboxyl group,
   a hydrogen atom,
R₁₁ represents a —CH₃ group or an oxygen atom;
Z represents a —CH₂— group or an oxygen atom;
Ar represents an aryl group of 6 to 18 carbon atoms which may or may not be substituted with at least one of the following groups:
   an alkyl group of 1 to 6 carbon atoms,
   an alkenyl group of 2 to 4 carbon atoms,
   a heteroatom O, N or S,
   a halogen,
   an SiMe₃ group,
   a hydroxyl group (OH),
   a group (O-Alk) where Alk represents an alkyl group comprising from 1 to 15 carbon atoms, preferably from 1 to 12 carbon atoms, preferably from 1 to 10 carbon atoms, preferably from 1 to 5 carbon atoms, preferably CH₃ or C₂H₅;
m represents a natural integer between 1 and 8;
p represents a natural integer equal to 0 or 1;
q represents a natural integer between 0 and 100;
a represents a natural integer equal to 1 or 2;
b represents a natural integer between 0 and 100.

According to one embodiment, the method of the invention is characterized in that the radical photoinitiator B is a compound of formula (XVII) indicated above:
in which R₉ and R₁₀, which may be identical or different, represent:
   an alkyl group comprising from 1 to 15 carbon atoms, preferably from 1 to 5 carbon atoms, preferably methyl,
   a hydroxyl group (OH),
   a hydrogen atom
R₁₁ represents a —CH₃ group or an oxygen atom;
Z represents a —CH₂— group or an oxygen atom;
Ar represents an aryl group of 6 carbon atoms which may or may not be substituted with at least one of the following groups:
   an alkyl group of 1 to 6 carbon atoms,
   an alkenyl group of 2 to 4 carbon atoms,
   a heteroatom O, N or S,
   a halogen,
   an SiMe₃ group,
   a hydroxyl group (OH),
m represents a natural integer between 1 and 8;
p represents a natural integer equal to 0 or 1;
q represents a natural integer between 0 and 10;
a represents a natural integer equal to 1 or 2;
b represents a natural integer between 0 and 20.

In one embodiment, the method of the invention is characterized in that the radical photoinitiator B is a compound of formula (XIX):

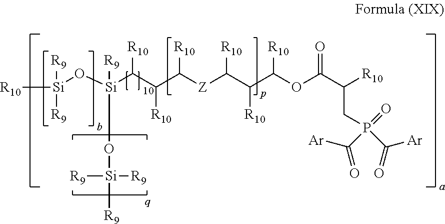

in which:
R₉ and R₁₀, which may be identical or different, represent:
   an alkyl group comprising from 1 to 15 carbon atoms, preferably from 1 to 12 carbon atoms, preferably from 1 to 10 carbon atoms, preferably from 1 to 5 carbon atoms, preferably methyl,
   an aryl group comprising from 6 to 10 carbon atoms, preferably phenyl;
   an alkenyl group comprising from 2 to 6 carbon atoms, preferably vinyl;
   a hydroxyl group (OH),
   a group (O-Alk) where Alk represents an alkyl group comprising from 1 to 15 carbon atoms, preferably from 1 to 12 carbon atoms, preferably from 1 to 10 carbon atoms, preferably from 1 to 5 carbon atoms, preferably CH₃ or C₂H₅,
   a group (O-Alk)ₓ with Alk representing an alkyl group comprising from 1 to 15 carbon atoms, preferably from 1 to 12 carbon atoms, preferably from 1 to 10 carbon atoms, preferably from 1 to 5 carbon atoms, preferably methyl, and x represents an integer between 2 and 200,
   an acrylate or meth (acrylate) group,
   a linear or branched alkyl group comprising from 1 to 10 carbon atoms, preferably from 1 to 5 carbon atoms, substituted with at least one fluorine atom, for example 1 to 10 fluorine atoms, for example (C₁-C₅)alkyl-CF₃, the alkyl being linear or branched,
   an amino group chosen from (Alk)-NH₂ or (Alk)-NH-(Alk)-NH₂, with Alk representing an alkyl comprising from 1 to 5 carbon atoms,
   a carbonyl or carboxyl group,
   a hydrogen atom,
R₁₁ represents a —CH₃ group or an oxygen atom;
Z represents a —CH₂— group or an oxygen atom;
Ar represents an aryl group of 6 to 18 carbon atoms which may or may not be substituted with at least one of the following groups:
   an alkyl group of 1 to 6 carbon atoms,
   an alkenyl group of 2 to 4 carbon atoms,
   a heteroatom O, N or S,
   a halogen,
   an SiMe₃ group,
   a hydroxyl group (OH),
   a group (O-Alk) where Alk represents an alkyl group comprising from 1 to 15 carbon atoms, preferably from 1 to 12 carbon atoms, preferably from 1 to 10 carbon atoms, preferably from 1 to 5 carbon atoms, preferably CH₃ or C₂H₅;
m represents a natural integer between 1 and 8;
p represents a natural integer equal to 0 or 1;
q represents a natural integer between 0 and 100;
a represents a natural integer equal to 1 or 2;
b represents a natural integer between 0 and 100;
said method is characterized in that when a=1:
q>0 or at least one group R₉ is a hydroxyl group.

According to one embodiment, the method of the invention is characterized in that the radical photoinitiator B is a compound of formula (XIX) indicated above:
in which Ry and R₁₀, which may be identical or different, represent:
   an alkyl group comprising from 1 to 15 carbon atoms, preferably from 1 to 5 carbon atoms, preferably methyl,
   a hydroxyl group (OH),
   a hydrogen atom
R₁₁ represents a —CH₃ group or an oxygen atom;
Z represents a —CH₂— group or an oxygen atom;
Ar represents an aryl group of 6 carbon atoms which may or may not be substituted with at least one of the following groups:
   an alkyl group of 1 to 6 carbon atoms,
   an alkenyl group of 2 to 4 carbon atoms,
   a heteroatom O, N or S,
   a halogen,
   an SiMe₃ group,
   a hydroxyl group (OH),
m represents a natural integer between 1 and 8;
p represents a natural integer equal to 0 or 1;
q represents a natural integer between 0 and 10;
a represents a natural integer equal to 1 or 2;
b represents a natural integer between 0 and 20;
said method is characterized in that when a=1:
q>0 or at least one group R₉ is a hydroxyl group.

In one embodiment, the method of the invention is characterized in that the photocrosslinkable composition X also comprises a photoinitiator chosen from the group consisting of radical photoinitiators of type I or radical photoinitiators of type II.

Thus, the photocrosslinkable composition X may also comprise a photoinitiator chosen from the group of type I radical photoinitiators such as:
acyl phosphine oxides, bis-acyl phosphine oxides and derivatives thereof, for instance diphenyl(2,4,6-trimethylbenzoyl) phosphine oxide (TPO), ethyl (2,4,6-trimethylbenzoyl)phenylphosphinate (TPO-L), phenyl bis(2,4,6-trimethylbenzoyl) phosphine oxide (BAPO), benzoin ether, benzoyl oxime, acetophenone & hydroxyacetophenone (HAP), phenylglyoxal, alpha-hydroxy ketones, alpha-amino ketones and CPO-1 & CPO-2.

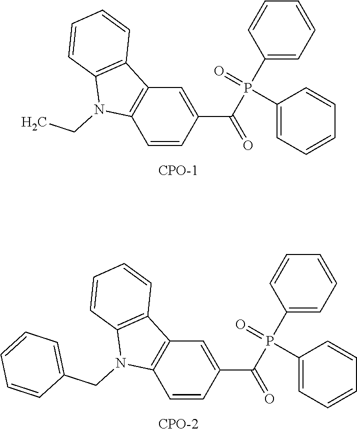

As examples of commercial products of such photoinitiators, mention may notably be made of:
bis(2,4,6-trimethylbenzoyl)phenyl phosphine oxide sold under the name Omnirad™ 819 by IGM Resin B.V.; liquid mixtures of acylphosphine oxides with at least one other photoinitiator sold by IGM Resin B.V. under the name Omnirad™ 1000, Omnirad™ 2022, Omnirad™ 2100 or Omnirad™ 4265; 4-(2-hydroxyethoxy)phenyl(2-hydroxy-2-propyl), 2-hydroxy-2-methylpropiophenone sold by IGM Resin B.V. under the name Omnirad™ 1173; 2-benzyl-2-(N,N-dimethylamino)-1-(4-morpholinophenyl)-1-butanone sold by IGM Resin B.V. under the name Omnirad™ 369 or as Irgacure® 369 by Ciba®); 2,2-dimethoxy-1,2-diphenylethan-1-one sold by Ciba® under the name Irgacure® 651; 2-methyl-1-[4-(methylthio)phenyl]-2-morpholinopropan-1-one sold by IGM Resin B.V. under the name Omnirad™ 907 or as Irgacure® 907 by Ciba®); 2-hydroxy-2-methyl-1-phenyl-1-propanone sold by Ciba® under the name Darocure® 1173; 1-hydroxycyclohexyl phenyl ketone type I (Irgacure 184).

Thus, the photocrosslinkable composition X may also comprise a photoinitiator chosen from the group of type II radical photoinitiators such as:
benzophenones, for instance 1-hydroxycyclohexyl benzophenone sold by IGM Resin B.V. under the name Omnirad™ 184; thioxanthones, for instance isopropylthioxanthone, thioxanthone neodecanoate or substituted thioxanthones as disclosed in patent application WO 2018/234643; xanthenes, such as 9-xanthenone; anthraquinones and hydroxyanthraquinones such as 4-dihydroxyanthraquinone, 2-methylanthraquinone, 2,2′-bis(3-hydroxy-1,4-naphthoquinone), 2,6-dihydroxyanthraquinone, 1,5-dihydroxyanthraquinone, 2-ethylanthraquinone, 2-methylanthraquinone, 1,8-dihydroxyanthraquinone, 1,3-diphenyl-1,3-propanedione, 5,7-dihydroxyflavone.

In one embodiment, the method of the invention is characterized in that the weight-average molecular mass of the radical photoinitiator B is between 400 and 10 000 g/mol, preferably between 400 and 5000, preferentially between 400 and 3000, even more preferentially between 400 and 2600 g/mol.

In one embodiment, the method of the invention is characterized in that the mass percentage of radical photoinitiator B is between 0.1% and 20% relative to the total mass of the photocrosslinkable composition X, preferably between 0.1% and 5%, preferentially between 0.2% and 2%, more preferentially between 0.4% and 1.5% relative to the total mass of the photocrosslinkable composition X.

In one embodiment, the method of the invention is characterized in that the radical photoinitiator B and the organopolysiloxane A are one and the same molecule, denoted AB.

The system is then called an “intramolecular system”.

In one embodiment, the method of the invention is characterized in that compound AB is a compound of formula (XXa), (XXb), (XXc) or (XXd):

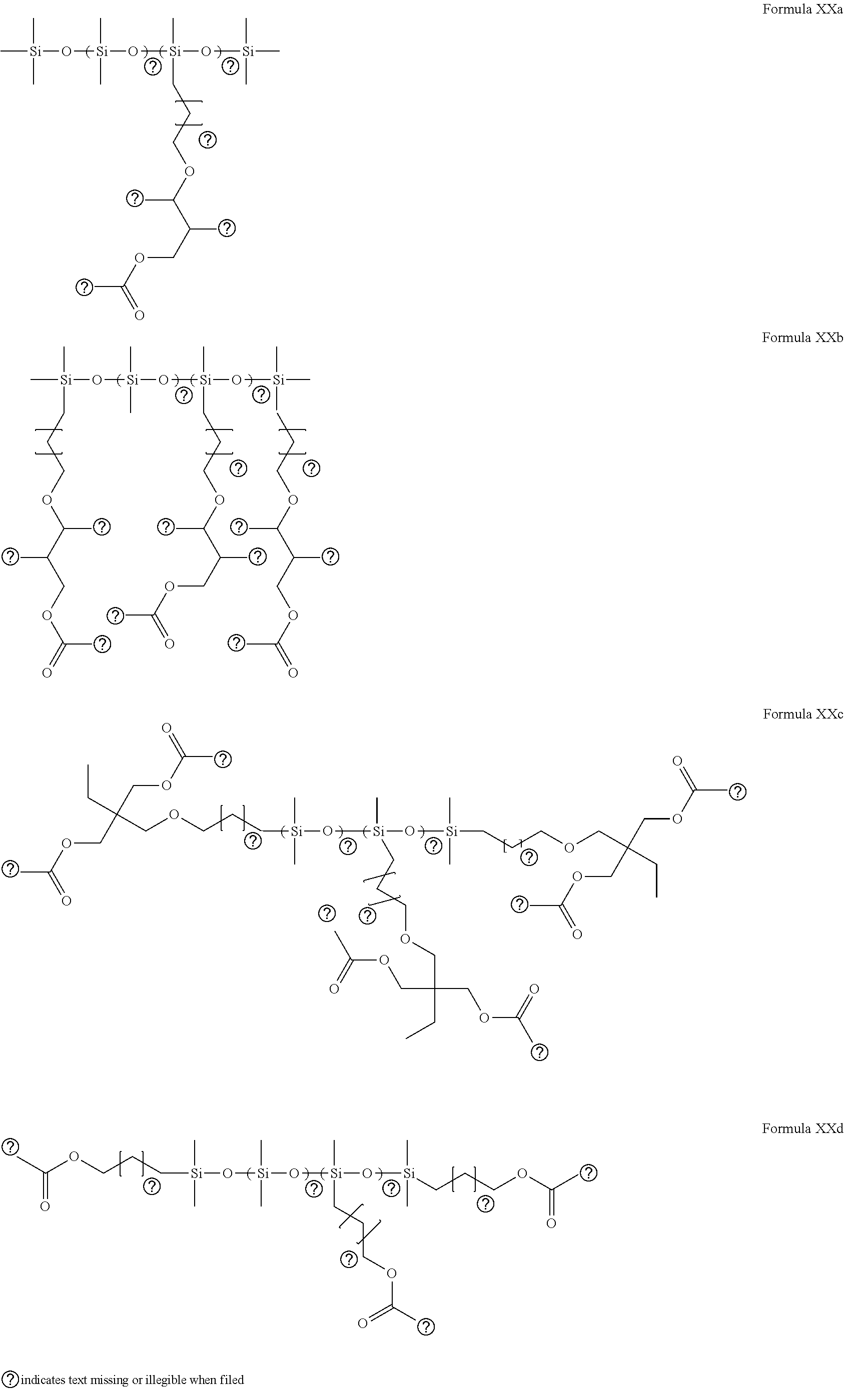

in which:
R₁₂, which may be identical or different, represents a hydrogen atom or a hydroxyl group;
R₁₃, which may be identical or different, represents:
   an alkenyl function of 2 to 4 carbon atoms,
   at least one group of formula (XXI):

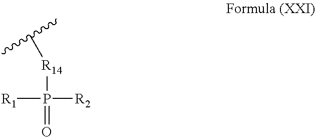

R₁ and R₂ represent the groups as defined previously;
R₁₄ represents:
an alkyl group of 1 to 5 carbon atoms or an alkenyl group of 2 to 5 carbon atoms:
   optionally substituted with at least one heteroatom O, N or S,
   optionally substituted with at least one alkyl group of 1 to 5 carbon atoms,
   optionally substituted with at least one aryl group of 6 to 18 carbon atoms,
   x₁ is an integer between 1 and 1000; preferably x₁ is between 1 and 500;
   n₁ is an integer between 1 and 100, preferably n₁ is between 2 and 50;
   x₂ is an integer between 1 and 1000, preferably x₂ is between 1 and 500;
   n₂ is an integer between 0 and 100, preferably n₂ is between 0 and 50;
   x₃ is an integer between 1 and 1000, preferably x₃ is between 1 and 500; and
   n₃ is an integer between 0 and 100, preferably n₃ is between 0 and 50.
   x₄ is an integer between 1 and 1000, preferably x₄ is between 1 and 500; and
   n₄ is an integer between 0 and 100, preferably n₄ is between 0 and 50;
   m₁, m₂, m₃ and m₄ are integers between 1 and 8.

In one embodiment, the method of the invention is characterized in that compound AB is a compound of formula (XXIIa), (XXIIb), (XXIIc) or (XXIId):

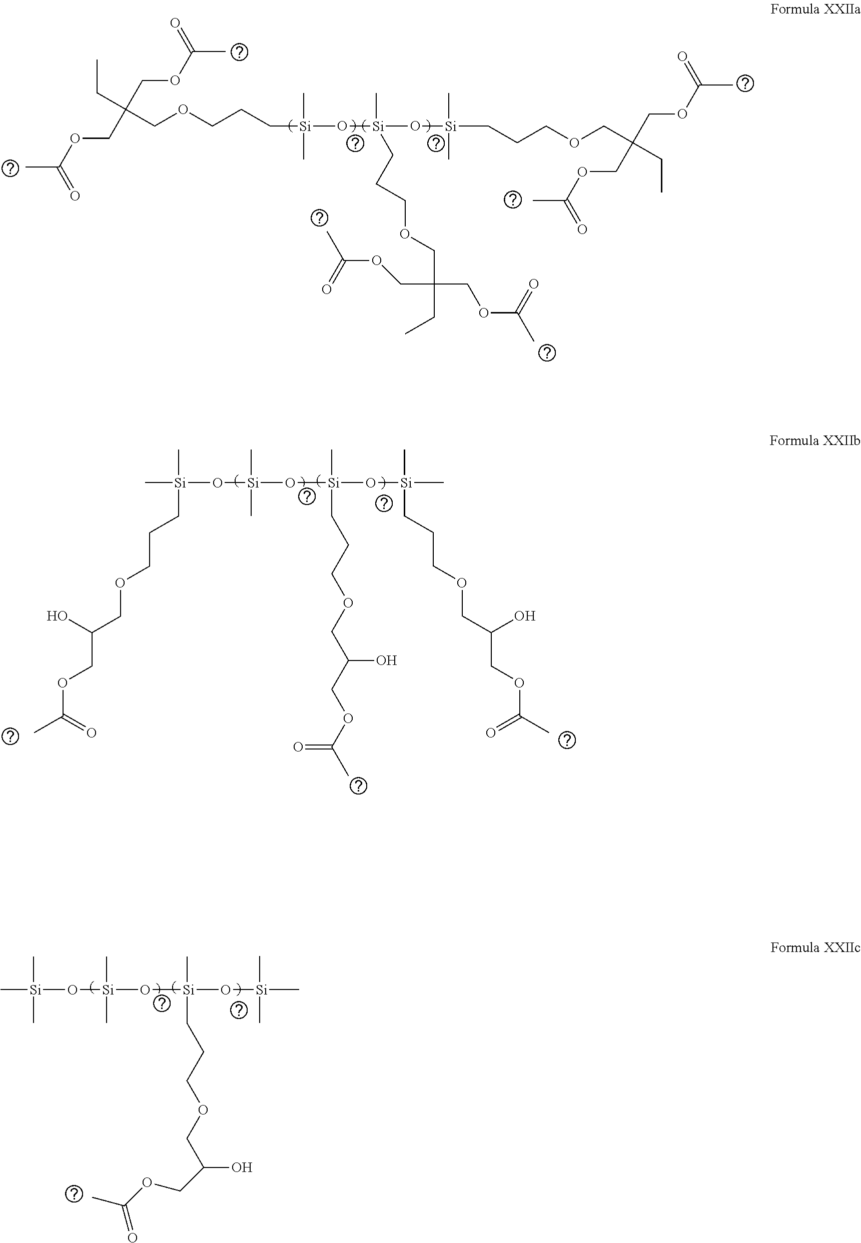

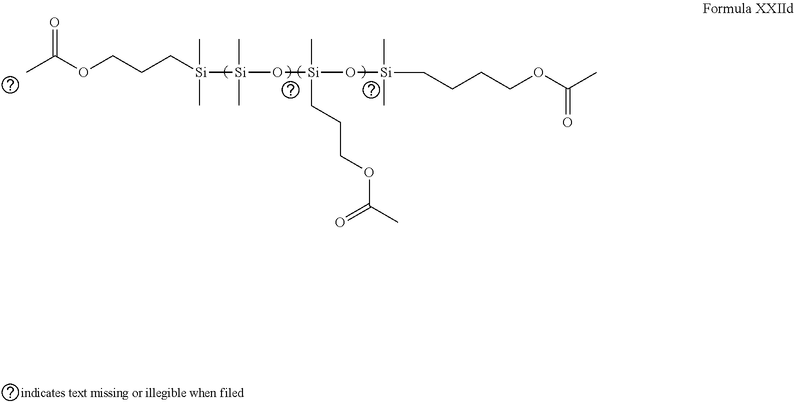

in which:
R₁₄, which may be identical or different, represents:
   an alkenyl function of 2 to 4 carbon atoms,
   at least one group of formula (XXIII):

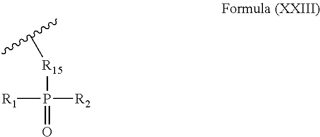

R₁ and R₂ represent the groups as defined previously;
R₁₅ represents:
an alkyl group of 1 to 5 carbon atoms or an alkenyl group of 2 to 5 carbon atoms:
   optionally substituted with at least one heteroatom O, N or S,
   optionally substituted with at least one alkyl group of 1 to 5 carbon atoms,
   optionally substituted with at least one aryl group of 6 to 18 carbon atoms,
   x₁ is between 1 and 1000; preferably x₁ is between 1 and 500;
   n₁ is between 0 and 100, preferably n₁ is between 0 and 50;
   x₂ is between 1 and 1000, preferably x₂ is between 1 and 500;
   n₂ is between 1 and 100, preferably n₂ is between 2 and 50;
   x₃ is between 1 and 1000, preferably x₃ is between 1 and 500;
   n₃ is between 1 and 100, preferably n₃ is between 0 and 50;
   x₄ is between 1 and 1000, preferably x₄ is between 1 and 500;
   n₄ is an integer between 0 and 100, preferably n₄ is between 0 and 50.

Other additives:

In one embodiment, the method of the invention is characterized in that the photocrosslinkable silicone composition X comprises:
from 10% to 99.9% of at least one organopolysiloxane A including at least one (meth)acrylate group as defined previously;
from 0.1% to 20% of at least one radical photoinitiator B as defined previously.

The photocrosslinkable silicone composition X may also comprise other additives such as polymerization inhibitors, fillers, virucides, bactericides, anti-abrasion additives and pigments (organic or mineral).

Among the polymerization inhibitors, mention may be made of phenols, hydroquinone, 4-OMe-phenol, 2,4,6-tri (tert-butyl) phenol (BHT), phenothiazine, and nitroxyl radicals such as (2,2,6,6-tetramethylpiperidin-1-yl)oxy (TEMPO).

The photocrosslinkable silicone composition X may also comprise an organic compound O comprising at least one (meth)acrylate function.

The term “organic compound O comprising at least one (meth)acrylate function” means any compound comprising one or more (meth)acrylate functions.

According to one embodiment, the organic compound O comprising at least one (meth)acrylate function does not comprise any siloxane structure.

The organic compounds O comprising a (meth)acrylate function that are notably suitable for use are epoxidized (meth)acrylates, (meth)acryloglyceropolyesters, (meth)acrylourethanes, (meth)acrylopolyethers, (meth)acrylopolyesters and (meth)acrylo-acrylics. More particularly preferred are trimethylolpropane triacrylate, tripropylene glycol diacrylate, hexanediol diacrylate and pentaerythritol tetraacrylate.

As examples of organic compounds O comprising a (meth)acrylate function, mention may be made, for example, of ethylhexyl acrylate, stearyl acrylate, tetrahydrofurfuryl acrylate, lauryl acrylate, isodecyl acrylate, 2-(2-ethoxyethoxy)ethyl acrylate, cyclohexyl acrylate, isooctyl acrylate, tridecyl acrylate, isobornyl acrylate, caprolactone acrylate, alkoxylated phenol acrylates, 1,3-butylene glycol diacrylate, 1,4-butanediol diacrylate, diethylene glycol diacrylate, neopentyl glycol diacrylate, tetraethylene glycol diacrylate, triethylene glycol diacrylate, dipropylene glycol diacrylate, alkoxylated hexanediol diacrylates, trimethylolpropane triacrylate, ethoxylated trimethylolpropane triacrylate, propoxylated glycerol triacrylate, pentaerythritol triacrylate, pentaerythritol tetraacrylate, ditrimethylolpropane tetraacrylate, and dipentaerythritol pentaacrylate.

The photocrosslinkable silicone composition X may comprise from 0 to 50% of organic compound O relative to the total mass of the photocrosslinkable silicone composition X.

According to one embodiment, the photocrosslinkable silicone composition X also comprises a filler D.

The photocrosslinkable silicone composition X may comprise from 0 to 50% by mass of filler D, preferably from 10% to 50% of filler D, preferentially from 10% to 40% of filler D, even more preferentially from 20% to 35% of filler D relative to the total mass of the photocrosslinkable silicone composition X.

According to one embodiment, the photocrosslinkable silicone composition X comprises between 20% and 30% by mass of D filler relative to the total mass of the photocrosslinkable silicone composition X.

This filler is preferably mineral. The filler D may be a very finely divided product with an average particle diameter of less than 0.1 μm.

The filler D may notably be siliceous. As regards siliceous materials, they may act as reinforcing or semi-reinforcing fillers. The reinforcing siliceous fillers are chosen from colloidal silicas, combustion and precipitation silica powders, or mixtures thereof.

These powders generally have a mean particle size of less than 0.1 μm (micrometres) and a BET specific surface area of greater than 30 m²/g, preferably between 30 and 350 m₂/g.

Semi-reinforcing siliceous fillers such as diatomaceous earth or ground quartz may also be used.

These silicas may be incorporated as they are or after having been treated with organosilicon compounds usually used for this purpose. These compounds include methylpolysiloxanes such as hexamethyldisiloxane, octamethylcyclotetrasiloxane, methylpolysilazanes such as hexamethyldisilazane, hexamethylcyclotrisilazane, tetramethyldivinyldisilazane, chlorosilanes such as dimethyldichlorosilane, trimethylchlorosilane, methylvinyldichlorosilane, dimethylvinylchlorosilane, alkoxysilanes such as dimethyldimethoxysilane, dimethylvinylethoxysilane, trimethylmethoxysilane, and mixtures thereof. As regards non-siliceous minerals, they may be used as semi-reinforcing or bulking mineral fillers.

Examples of these non-siliceous fillers, which may be used alone or as mixtures, are calcium carbonate, optionally surface-treated with an organic acid or with an ester of an organic acid, calcined clay and rutile-type titanium oxide, iron, zinc, chromium, zirconium and magnesium oxides, various forms of alumina (hydrated or not), boron nitride, lithopone, barium metaborate, barium sulfate and glass microspheres.

These fillers are coarser, generally with an average particle diameter greater than 0.1 μm and a specific surface area generally less than 30 m²/g.

These fillers may have been surface modified by treatment with the various organosilicon compounds usually used for this purpose.

Thus, according to one embodiment, the method according to the invention is characterized in that the photocrosslinkable silicone composition X comprises:
from 10% to 89.9% of at least one organopolysiloxane A including at least one (meth)acrylate group as defined previously;
from 0.1% to 20% of at least one radical photoinitiator B as defined previously;
from 10% to 50% of filler D.

The photocrosslinkable silicone composition X may also comprise a photoabsorber E.

The photoabsorber E allows the penetration of the irradiation into the layer of photocrosslinkable silicone composition X to be reduced and thus the resolution of the silicone elastomer article obtained to be improved. It allows the depth of irradiation penetration (Dp) into the silicone elastomer layer to be controlled.

The photocrosslinkable silicone composition X comprises from 0.01% to 5% by mass of photoabsorber E relative to the total mass of the photocrosslinkable silicone composition X, and preferably the photoabsorber E is chosen from the group consisting of TiO₂, ZnO, hydroxylphenyl-s-triazines, hydroxylphenyl-benzotriazoles such as Tinuvin® 384-2, cyanoacrylates, and mixtures thereof. According to one embodiment of the invention, the photocrosslinkable silicone composition X comprises from 0.01% to 1.5% by mass of photoabsorber E relative to the total mass of the photocrosslinkable silicone composition X, preferably from 0.01% to 0.5%, preferentially from 0.01% to 0.2% relative to the total mass of the photocrosslinkable silicone composition X.

The photocrosslinkable silicone composition X may also comprise a photostabilizer F.

The photostabilizer F allows the activity of the photoinitiators to be reduced or even stopped, by trapping the radicals which are still active after the method of the present invention has been performed. This thus allows the transparency properties of the silicone elastomer article obtained according to the method of the invention to be increased.

The photocrosslinkable silicone composition X also comprises from 0 to 2% by mass of photostabilizer F relative to the total mass of the photocrosslinkable silicone composition X, and preferably from 0 to 0.5% by mass of photostabilizer F relative to the total mass of the photocrosslinkable silicone composition X.

Said photostabilizer F is chosen from the group consisting of hindered amines, cyclic amines of 4 to 6 carbon atoms, such as the commercial compounds Tinuvin® 249, Tinuvin®292, Tinuvin®123 and mixtures thereof.

### Photocrosslinkable Composition X2:

The invention also relates to the photocrosslinkable silicone composition X2 comprising:
from 10% to 99.9% by mass of at least one organopolysiloxane A including at least one (meth)acrylate group;
from 0.1% to 20% by mass of at least one radical photoinitiator B which is a compound of formula (I):

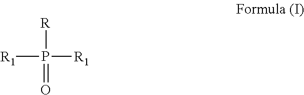

in which:
R represents a linear or branched C₁-C₅₀ alkylene or heteroalkylene group, preferably a linear or branched C₁-C₁₈ alkylene or heteroalkylene group, said alkylene and heteroalkylene groups comprising at least one siloxane function;
R₁ represents a group of formula (II):

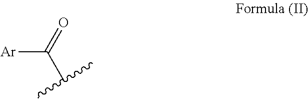

in which Ar represents an aryl group of 6 to 18 carbon atoms, which is unsubstituted or substituted with at least one of the following groups:
   an alkyl group of 1 to 6 carbon atoms,
   an alkenyl group of 2 to 4 carbon atoms,
   a heteroatom O, N or S,
   a halogen,
   an SiMe₃ group,
   a hydroxyl group (OH),
   a group (O-Alk) where Alk represents an alkyl group comprising from 1 to 15 carbon atoms, preferably from 1 to 12 carbon atoms, preferably from 1 to 10 carbon atoms, preferably from 1 to 5 carbon atoms, preferably CH₃ or C₂H₅;
R₂ represents:
   a group R₁,
   an aryl group of 6 to 18 carbon atoms, which is unsubstituted or substituted with at least one of the following groups:
   an alkyl group of 1 to 6 carbon atoms,
   an alkenyl group of 2 to 4 carbon atoms,
   a heteroatom O, N or S,
   a halogen,
   an SiMe₃ group,
   a hydroxyl group (OH),
   a group (O-Alk) where Alk represents an alkyl group comprising from 1 to 15 carbon atoms, preferably from 1 to 12 carbon atoms, preferably from 1 to 10 carbon atoms, preferably from 1 to 5 carbon atoms, preferably CH₃ or C₂H₅.

Advantageously, the photoinitiator B of the photocrosslinkable composition X2 is a compound chosen from the compounds of formula: (VIII), (XIII), (XVII), (XXa), (XXb), (XXc), (XXd) and/or mixtures thereof.

Preferably, the photoinitiator B of the photocrosslinkable composition X2 is a compound chosen from the compounds of formula: (VIII), (XIII), (XVII), (XXa) and/or mixtures thereof.

Thus, according to one embodiment, the photocrosslinkable silicone composition X2 comprises:
from 10% to 99.9% by mass of at least one organopolysiloxane A including at least one (meth)acrylate group;
from 0.1% to 20% by mass of at least one photoinitiator B which is a compound of formula (XXIV):

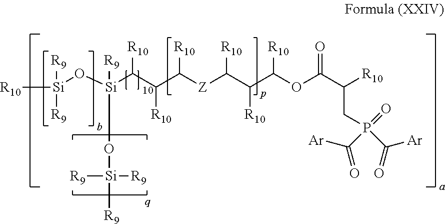

in which R₉, which may be identical or different, represents:
   an alkyl group comprising from 1 to 15 carbon atoms, preferably from 1 to 12 carbon atoms, preferably from 1 to 10 carbon atoms, preferably from 1 to 5 carbon atoms, preferably methyl,
   an aryl group comprising from 6 to 10 carbon atoms, preferably phenyl;
   an alkenyl group comprising from 2 to 6 carbon atoms, preferably vinyl;
   a hydroxyl group (OH),
   a group (O-Alk) where Alk represents an alkyl group comprising from 1 to 15 carbon atoms, preferably from 1 to 12 carbon atoms, preferably from 1 to 10 carbon atoms, preferably from 1 to 5 carbon atoms, preferably CH₃ or C₂H₅,
   a group (O-Alk)ₓ with Alk representing an alkyl group comprising from 1 to 15 carbon atoms, preferably from 1 to 12 carbon atoms, preferably from 1 to 10 carbon atoms, preferably from 1 to 5 carbon atoms, preferably methyl, and x represents an integer between 2 and 200,
   an acrylate or meth (acrylate) group,
   a linear or branched alkyl group comprising from 1 to 10 carbon atoms, preferably from 1 to 5 carbon atoms, substituted with at least one fluorine atom, for example 1 to 10 fluorine atoms, for example (C₁-C₅)alkyl-CF₃, the alkyl being linear or branched,
   an amino group chosen from (Alk)-NH₂ or (Alk)-NH-(Alk)-NH₂, with Alk representing an alkyl comprising from 1 to 5 carbon atoms,
   a carbonyl or carboxyl group,
   a hydrogen atom,
   a group of formula (XXV):

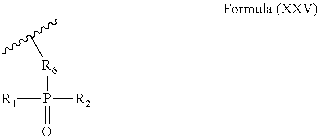

in which R₁ and R₂ represent groups as defined previously;
R₆ represents a linear or branched C₁-C₅₀ alkylene or heteroalkylene group, preferably a linear or branched C₁-C₁₈ alkylene or heteroalkylene group;
R₁₀, which may be identical or different, represents:
   an alkyl group comprising from 1 to 15 carbon atoms, preferably from 1 to 12 carbon atoms, preferably from 1 to 10 carbon atoms, preferably from 1 to 5 carbon atoms, preferably methyl,
   an aryl group comprising from 6 to 10 carbon atoms, preferably phenyl;
   an alkenyl group comprising from 2 to 6 carbon atoms, preferably vinyl;
   a hydroxyl group (OH),
   a group (O-Alk) where Alk represents an alkyl group comprising from 1 to 15 carbon atoms, preferably from 1 to 12 carbon atoms, preferably from 1 to 10 carbon atoms, preferably from 1 to 5 carbon atoms, preferably CH₃ or C₂H₅,
   a group (O-Alk)ₓ with Alk representing an alkyl group comprising from 1 to 15 carbon atoms, preferably from 1 to 12 carbon atoms, preferably from 1 to 10 carbon atoms, preferably from 1 to 5 carbon atoms, preferably methyl, and x represents an integer between 2 and 200,
   an acrylate or meth (acrylate) group,
   a linear or branched alkyl group comprising from 1 to 10 carbon atoms, preferably from 1 to 5 carbon atoms, substituted with at least one fluorine atom, for example 1 to 10 fluorine atoms, for example (C₁-C₅)alkyl-CF₃, the alkyl being linear or branched,
   an amino group chosen from (Alk)-NH₂ or (Alk)-NH-(Alk)-NH₂, with Alk representing an alkyl comprising from 1 to 5 carbon atoms,
   a carbonyl or carboxyl group,
   a hydrogen atom,
R₁₁ represents a —CH₃ group or an oxygen atom;
Z represents a —CH₂— group or an oxygen atom;
Ar represents an aryl group of 6 to 18 carbon atoms which may or may not be substituted with at least one of the following groups:
   an alkyl group of 1 to 6 carbon atoms,
   an alkenyl group of 2 to 4 carbon atoms,
   a heteroatom O, N or S,
   a halogen,
   an SiMe₃ group,
   a hydroxyl group (OH),
   a group (O-Alk) where Alk represents an alkyl group comprising from 1 to 15 carbon atoms, preferably from 1 to 12 carbon atoms, preferably from 1 to 10 carbon atoms, preferably from 1 to 5 carbon atoms, preferably CH₃ or C₂H₅;
   m represents a natural integer between 1 and 8;
   p represents a natural integer equal to 0 or 1;
   q represents a natural integer between 0 and 100;
   a represents a natural integer equal to 1 or 2;
   b represents a natural integer between 0 and 100.

According to one embodiment, the photocrosslinkable silicone composition X2 is characterized in that the radical photoinitiator B is a compound of formula (XIX) indicated above:
in which R₉ and R₁₀, which may be identical or different, represent:
   an alkyl group comprising from 1 to 15 carbon atoms, preferably from 1 to 5 carbon atoms, preferably methyl,
   a hydroxyl group (OH),
   a hydrogen atom
R₁₁ represents a —CH₃ group or an oxygen atom;
represents a —CH₂— group or an oxygen atom;
Ar represents an aryl group of 6 carbon atoms which may or may not be substituted with at least one of the following groups:
   an alkyl group of 1 to 6 carbon atoms,
   an alkenyl group of 2 to 4 carbon atoms,
   a heteroatom O, N or S,
   a halogen,
   an SiMe₃ group,
   a hydroxyl group (OH),
m represents a natural integer between 1 and 8;
p represents a natural integer equal to 0 or 1;
q represents a natural integer between 0 and 10;
a represents a natural integer equal to 1 or 2;
b represents a natural integer between 0 and 20.

In a preferred embodiment, the photocrosslinkable silicone composition X2 comprises:
from 25% to 89.9% by mass of at least one organopolysiloxane A including at least one (meth)acrylate group;
from 10% to 50% of filler D;
from 0.1% to 15% by mass of at least one radical photoinitiator B which is a compound of formula (XXVI):

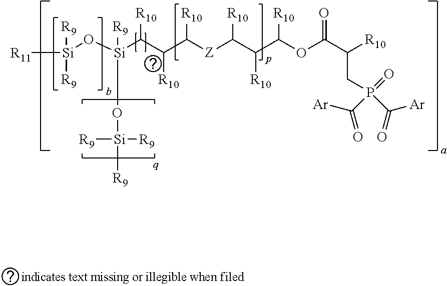

Formula (XXVI)
in which R₉, which may be identical or different, represents:
   an alkyl group comprising from 1 to 15 carbon atoms, preferably from 1 to 12 carbon atoms, preferably from 1 to 10 carbon atoms, preferably from 1 to 5 carbon atoms, preferably methyl,
   an aryl group comprising from 6 to 10 carbon atoms, preferably phenyl;
   an alkenyl group comprising from 2 to 6 carbon atoms, preferably vinyl;
   a hydroxyl group (OH),
   a group (O-Alk) where Alk represents an alkyl group comprising from 1 to 15 carbon atoms, preferably from 1 to 12 carbon atoms, preferably from 1 to 10 carbon atoms, preferably from 1 to 5 carbon atoms, preferably CH₃ or C₂H₅,
   a group (O-Alk)ₓ with Alk representing an alkyl group comprising from 1 to 15 carbon atoms, preferably from 1 to 12 carbon atoms, preferably from 1 to 10 carbon atoms, preferably from 1 to 5 carbon atoms, preferably methyl, and x represents an integer between 2 and 200,
   an acrylate or meth (acrylate) group,
   a linear or branched alkyl group comprising from 1 to 10 carbon atoms, preferably from 1 to 5 carbon atoms, substituted with at least one fluorine atom, for example 1 to 10 fluorine atoms, for example (C₁-C₅)alkyl-CF₃, the alkyl being linear or branched,
   an amino group chosen from (Alk)-NH₂ or (Alk)-NH-(Alk)-NH₂, with Alk representing an alkyl comprising from 1 to 5 carbon atoms,
   a carbonyl or carboxyl group,
   a hydrogen atom,
   a group of formula (XXVII):

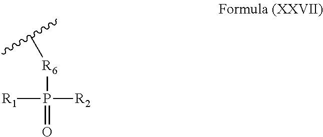

in which R₁ and R₂ represent groups as defined previously;
R₆ represents a linear or branched C₁-C₅₀ alkylene or heteroalkylene group, preferably a linear or branched C₁-C₁₈ alkylene or heteroalkylene group,
R₁₀, which may be identical or different, represents:
   an alkyl group comprising from 1 to 15 carbon atoms, preferably from 1 to 12 carbon atoms, preferably from 1 to 10 carbon atoms, preferably from 1 to 5 carbon atoms, preferably methyl,
   an aryl group comprising from 6 to 10 carbon atoms, preferably phenyl;
   an alkenyl group comprising from 2 to 6 carbon atoms, preferably vinyl;
   a hydroxyl group (OH),
   a group (O-Alk) where Alk represents an alkyl group comprising from 1 to 15 carbon atoms, preferably from 1 to 12 carbon atoms, preferably from 1 to 10 carbon atoms, preferably from 1 to 5 carbon atoms, preferably CH₃ or C₂H₅,
   a group (O-Alk)ₓ with Alk representing an alkyl group comprising from 1 to 15 carbon atoms, preferably from 1 to 12 carbon atoms, preferably from 1 to 10 carbon atoms, preferably from 1 to 5 carbon atoms, preferably methyl, and x represents an integer between 2 and 200,
   an acrylate or meth (acrylate) group,
   a linear or branched alkyl group comprising from 1 to 10 carbon atoms, preferably from 1 to 5 carbon atoms, substituted with at least one fluorine atom, for example 1 to 10 fluorine atoms, for example (C₁-C₅)alkyl-CF₃, the alkyl being linear or branched,
   an amino group chosen from (Alk)-NH₂ or (Alk)-NH-(Alk)-NH₂, with Alk representing an alkyl comprising from 1 to 5 carbon atoms,
   a carbonyl or carboxyl group,
   a hydrogen atom,
R₁₁ represents a —CH₃ group or an oxygen atom;
Z represents a —CH₂— group or an oxygen atom;
Ar represents an aryl group of 6 to 18 carbon atoms which may or may not be substituted with at least one of the following groups:
   an alkyl group of 1 to 6 carbon atoms,
   an alkenyl group of 2 to 4 carbon atoms,
   a heteroatom O, N or S,
   a halogen,
   an SiMe₃ group,
   a hydroxyl group (OH),
   a group (O-Alk) where Alk represents an alkyl group comprising from 1 to 15 carbon atoms, preferably from 1 to 12 carbon atoms, preferably from 1 to 10 carbon atoms, preferably from 1 to 5 carbon atoms, preferably CH₃ or C₂H₅;
m represents a natural integer between 1 and 8;
p represents a natural integer equal to 0 or 1;
q represents a natural integer between 0 and 100;
a represents a natural integer equal to 1 or 2;
b represents a natural integer between 0 and 100.

In a particularly preferred embodiment, said photocrosslinkable silicone composition X2 is characterized in that the radical photoinitiator B as represented by formula (XXVI) is further defined when a=1, q>0 or at least one group R₉ is a hydroxyl group;

According to one embodiment, the photocrosslinkable silicone composition X2 is characterized in that the radical photoinitiator B is a compound of formula (XXVI) indicated above:
in which R₉ and R₁₀, which may be identical or different, represent:
   an alkyl group comprising from 1 to 15 carbon atoms, preferably from 1 to 5 carbon atoms, preferably methyl,
   a hydroxyl group (OH),
   a hydrogen atom
R₁₁ represents a —CH₃ group or an oxygen atom;
Z represents a —CH₂— group or an oxygen atom;
Ar represents an aryl group of 6 carbon atoms which may or may not be substituted with at least one of the following groups:
   an alkyl group of 1 to 6 carbon atoms,
   an alkenyl group of 2 to 4 carbon atoms,
   a heteroatom O, N or S,
   a halogen,
   an SiMe₃ group,
   a hydroxyl group (OH),
m represents a natural integer between 1 and 8;
p represents a natural integer equal to 0 or 1;
q represents a natural integer between 0 and 10;
a represents a natural integer equal to 1 or 2;
b represents a natural integer between 0 and 20;
and when a=1:q>0 or at least one group R₉ is a hydroxyl group.

The photocrosslinkable silicone composition X2 also comprises at least one additive.

In a preferred embodiment, the additive is a filler, a photoabsorber or a photostabilizer, and mixtures thereof.

The photocrosslinkable silicone composition X2 may be used in very diverse technical fields such as printing inks, printing techniques, varnishes, wood coatings, plastic coatings, metal coatings, adhesives and 3D printing.

It can thus be used with coating tools used for preparing silicone release coatings.

The invention also relates to a process for preparing a coating on a support, comprising the following steps:
application of a photocrosslinkable silicone composition X2 to a support, and
crosslinking of said composition by electron or photon irradiation, preferably by exposure to an electron beam, by exposure to gamma rays, or by exposure to radiation with a wavelength of between 200 nm and 450 nm, notably UV radiation.

Advantageously, the photoinitiator B of the photocrosslinkable composition X2 is a compound chosen from the compounds of formula: (VIII), (XIII), (XVII), (XXa), (XXb), (XXc), (XXd) and/or mixtures thereof.

Preferably, the photoinitiator B of the photocrosslinkable composition X2 is a compound chosen from the compounds of formula: (VIII), (XIII), (XVII), (XXa) and/or mixtures thereof.

The solvent-free, i.e. undiluted, photocrosslinkable silicone composition X2 according to the invention may be applied using devices that are capable of uniformly depositing small amounts of liquids. To this end, use may be made, for example, of the “Helio glidant” device including, in particular, two superimposed rollers: the role of the lower roller, dipping into the coating tank where the compositions are located, is to impregnate the upper roller with a very thin layer, the role of the latter is then to deposit on the paper the desired amounts of the compositions with which it is impregnated, such metering being obtained by adjusting the respective speeds of the two rollers which rotate in opposite directions to each other.

Crosslinking, which is reflected by curing of the photocrosslinkable silicone composition X2, may be performed in a continuous manner by passing the support coated with the composition through irradiation equipment which is designed to provide the coated support with a residence time sufficient to complete the curing of the coating.

Preferably, the curing is performed in the presence of the lowest possible oxygen concentration, conventionally at an oxygen concentration of less than 100 ppm, and preferably less than 50 ppm. Curing is generally performed in an inert atmosphere, for example of nitrogen or argon.

The exposure time required to cure the silicone composition X2 varies with factors such as:
the particular formulation used, the type and wavelength of radiation,
dose rate, energy flow,
the concentration of free radical photoinitiator, and
the atmosphere and thickness of the coating.

These parameters are well known to those skilled in the art, who will be able to adapt them.

The amounts of photocrosslinkable silicone composition X2 deposited on the supports are variable and usually range from 0.1 to 5 g/m² of treated surface area. These amounts depend on the nature of the supports and the release properties required. They are usually between 0.5 and 1.5 g/m² for nonporous supports.

This process is particularly suitable for preparing a silicone release coating on a support which is a flexible support made of textile, paper, polyvinyl chloride, polyester, polypropylene, polyamide, polyethylene, polyethylene terephthalate, polyurethane or nonwoven glass fibers.

The flexible supports coated with a release silicone coating may be, for example:
a paper or polymer film of the polyolefin type (polyvinyl chloride (PVC), PolyPropylene or Polyethylene) or of the polyester type (PolyEthyleneTerephthalate or PET),
an adhesive tape, the inner face of which is coated with a layer of pressure-sensitive adhesive and the outer face of which includes the silicone release coating;
or a polymer film for protection of the adhesive face of a pressure-sensitive adhesive or self-adhesive element.

These coatings are particularly suitable for use in the antiadhesion field.

The invention also relates to a coated support which may be obtained according to the process described above. As indicated above, the support may be a flexible support made of textile, paper, polyvinyl chloride, polyester, polypropylene, polyamide, polyethylene, polyethylene terephthalate, polyurethane or nonwoven glass fibers.

The coated supports have a nonstick, water-repellent character, or allow improved surface properties such as glidance, stain resistance or softness.

Another subject of the invention relates to the use of a support at least partially coated with a release coating according to the invention and as defined above in the field of self-adhesive labels, tapes including envelopes, graphic arts, medical care and hygiene.

The invention also relates to photoinitiators of formula (XXVIII)

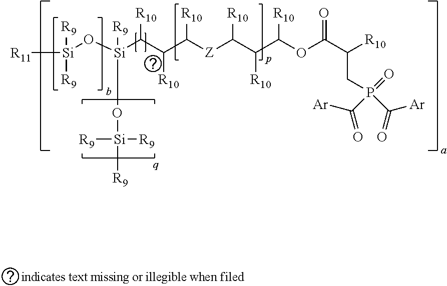

Formula (XXVIII)
in which:
R₉, which may be identical or different, represents:
   an alkyl group comprising from 1 to 15 carbon atoms, preferably from 1 to 12 carbon atoms, preferably from 1 to 10 carbon atoms, preferably from 1 to 5 carbon atoms, preferably methyl,
   an aryl group comprising from 6 to 10 carbon atoms, preferably phenyl;
   an alkenyl group comprising from 2 to 6 carbon atoms, preferably vinyl;
   a hydroxyl group (OH),
   a group (O-Alk) where Alk represents an alkyl group comprising from 1 to 15 carbon atoms, preferably from 1 to 12 carbon atoms, preferably from 1 to 10 carbon atoms, preferably from 1 to 5 carbon atoms, preferably CH₃ or C₂H₅,
   a group (O-Alk)ₓ with Alk representing an alkyl group comprising from 1 to 15 carbon atoms, preferably from 1 to 12 carbon atoms, preferably from 1 to 10 carbon atoms, preferably from 1 to 5 carbon atoms, preferably methyl, and x represents an integer between 2 and 200,
   an acrylate or meth (acrylate) group,
   a linear or branched alkyl group comprising from 1 to 10 carbon atoms, preferably from 1 to 5 carbon atoms, substituted with at least one fluorine atom, for example 1 to 10 fluorine atoms, for example (C₁-C₅)alkyl-CF₃, the alkyl being linear or branched,
   an amino group chosen from (Alk)-NH₂ or (Alk)-NH-(Alk)-NH₂, with Alk representing an alkyl comprising from 1 to 5 carbon atoms,
   a carbonyl or carboxyl group,
   a hydrogen atom,
   a group of formula (XXIX):

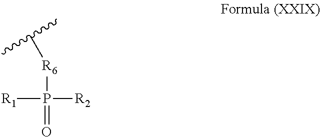

in which R₁ and R₂ represent groups as defined previously;
R₆ represents a linear or branched C₁-C₅₀ alkylene or heteroalkylene group, preferably a linear or branched C₁-C₁₈ alkylene or heteroalkylene group;
R₁₀, which may be identical or different, represents:
   an alkyl group comprising from 1 to 15 carbon atoms, preferably from 1 to 12 carbon atoms, preferably from 1 to 10 carbon atoms, preferably from 1 to 5 carbon atoms, preferably methyl,
   an aryl group comprising from 6 to 10 carbon atoms, preferably phenyl;
   an alkenyl group comprising from 2 to 6 carbon atoms, preferably vinyl;
   a hydroxyl group (OH),
   a group (O-Alk) where Alk represents an alkyl group comprising from 1 to 15 carbon atoms, preferably from 1 to 12 carbon atoms, preferably from 1 to 10 carbon atoms, preferably from 1 to 5 carbon atoms, preferably CH₃ or C₂H₅,
   a group (O-Alk)ₓ with Alk representing an alkyl group comprising from 1 to 15 carbon atoms, preferably from 1 to 12 carbon atoms, preferably from 1 to 10 carbon atoms, preferably from 1 to 5 carbon atoms, preferably methyl, and x represents an integer between 2 and 200,
   an acrylate or meth (acrylate) group,
   a linear or branched alkyl group comprising from 1 to 10 carbon atoms, preferably from 1 to 5 carbon atoms, substituted with at least one fluorine atom, for example 1 to 10 fluorine atoms, for example (C₁-C₅)alkyl-CF₃, the alkyl being linear or branched,
   an amino group chosen from (Alk)-NH₂ or (Alk)-NH-(Alk)-NH₂, with Alk representing an alkyl comprising from 1 to 5 carbon atoms,
   a carbonyl or carboxyl group,
   a hydrogen atom,
R₁₁ represents a —CH₃ group or an oxygen atom;
Z represents a —CH₂— group or an oxygen atom;
Ar represents an aryl group of 6 to 18 carbon atoms which may or may not be substituted with at least one of the following groups:
   an alkyl group of 1 to 6 carbon atoms,
   an alkenyl group of 2 to 4 carbon atoms,
   a heteroatom O, N or S,
   a halogen,
   an SiMe₃ group,
   a hydroxyl group (OH),
   a group (O-Alk) where Alk represents an alkyl group comprising from 1 to 15 carbon atoms, preferably from 1 to 12 carbon atoms, preferably from 1 to 10 carbon atoms, preferably from 1 to 5 carbon atoms, preferably CH₃ or C₂H₅;
m represents a natural integer between 1 and 8;
p represents a natural integer equal to 0 or 1;
q represents a natural integer between 0 and 100;
a represents a natural integer equal to 1 or 2;
b represents a natural integer between 0 and 100;
said photoinitiators being characterized in that when a=1:
q>0 or at least one group R₉ is a hydroxyl group.

According to one embodiment, the invention also relates to the photoinitiators of formula (XXVIII) indicated above:
in which R₉ and R₁₀, which may be identical or different, represent:
   an alkyl group comprising from 1 to 15 carbon atoms, preferably from 1 to 5 carbon atoms, preferably methyl,
   a hydroxyl group (OH),
   a hydrogen atom
R₁₁ represents a —CH₃ group or an oxygen atom;
Z represents a —CH₂— group or an oxygen atom;
Ar represents an aryl group of 6 carbon atoms which may or may not be substituted with at least one of the following groups:
   an alkyl group of 1 to 6 carbon atoms,
   an alkenyl group of 2 to 4 carbon atoms,
   a heteroatom O, N or S,
   a halogen,
   an SiMe₃ group,
   a hydroxyl group (OH),
m represents a natural integer between 1 and 8;
p represents a natural integer equal to 0 or 1;
q represents a natural integer between 0 and 10;
a represents a natural integer equal to 1 or 2;
b represents a natural integer between 0 and 20;
and when a=1:q>0 or at least one group R, is a hydroxyl group.

### EXAMPLES

### Organopolysiloxanes a Used in the Examples:

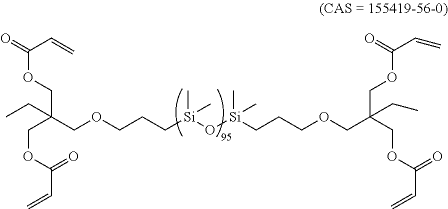

This silicone acrylate polymer having a molecular mass M_{w} of 7654 g/mol, will be referred to as polymer a₁ in the following examples.

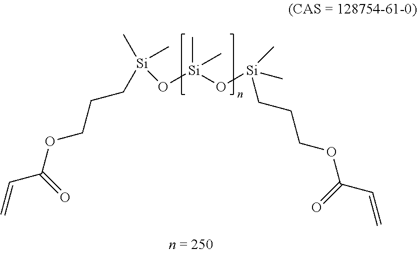

This silicone acrylate polymer having a molecular mass M_{w} of 18 714 g/mol will be referred to as polymer a₂ in the following examples.

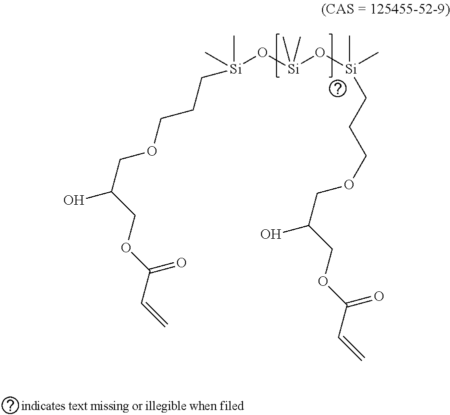

This silicone acrylate polymer having a molecular mass M_{w} of 18 862 g/mol will be referred to as polymer as in the following examples.

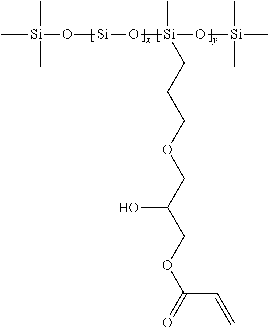

This silicone acrylate polymer having a molecular mass M_{w} of 8297 g/mol will be referred to as polymer a₄ in the following examples.

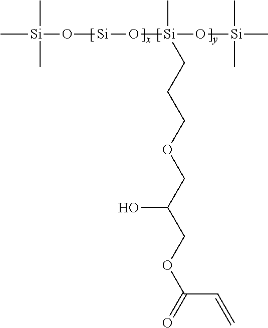

This silicone acrylate polymer having a molecular mass M_{w} of 2340 g/mol will be referred to as polymer as in the following examples.

### Photoinitiator B Used in the Examples:

In the following examples, the Mes group denotes the Mesityl group represented by the following formula:

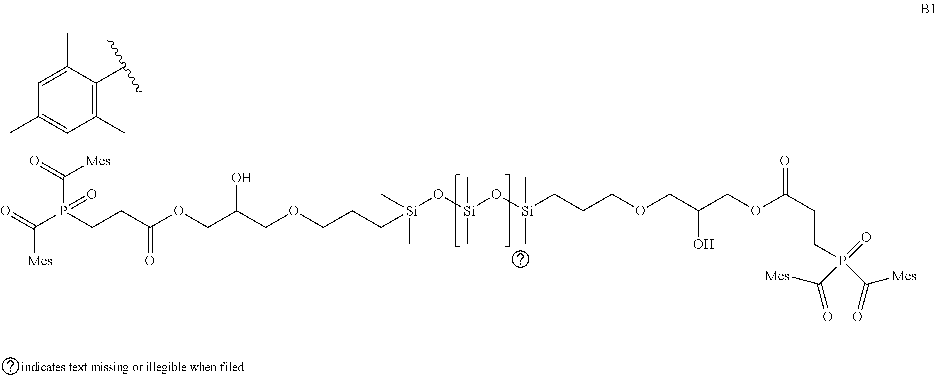

The photoinitiator of the present invention, B1, has a weight-average molecular mass M_{w} of 2600 g/mol.

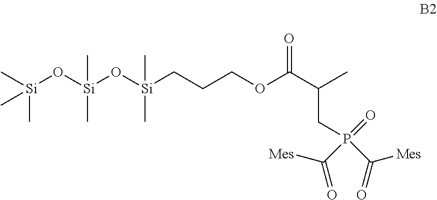

The photoinitiator of the present invention, B2, has a weight-average molecular mass M_{w} of 690 g/mol.

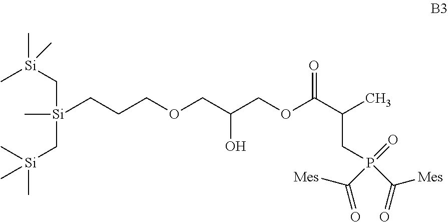

The photoinitiator of the present invention, B3, has a weight-average molecular mass M_{w} of 764 g/mol.

### Comparative Photoinitiator C:

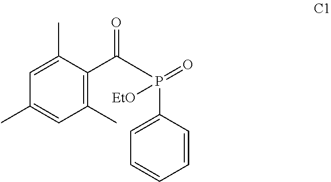 [SMILES: CCOP(=O)(C(=O)c1c(C)cc(C)cc1C)c1ccccc1]

This photoinitiator is ethyl (2,4,6-trimethylbenzoyl)phenylphosphinate known under the name TPO-L (CAS 84434-11-7) and will be denoted C1 in the examples below. This comparative photoinitiator has a weight-average molecular mass M_{w} of 316 g/mol.

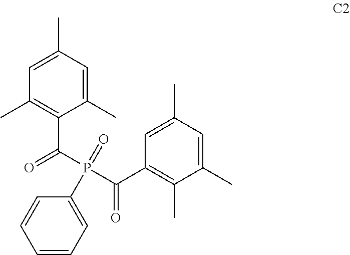

This photoinitiator is bis(2,4,6-trimethylbenzoyl)phenylphosphine oxide known under the name BAPO (CAS 162881-26-7) and will be denoted C₂ in the examples below. This comparative photoinitiator has a weight-average molecular mass M_{w} of 418 g/mol.

### Additives Used in the Examples:

Filler D1: Fumed silica surface-treated with SiMe₃ groups, with a BET specific surface area of 200 m²/g

Physical and/or Mechanical Properties:

Viscosity: In the context of the present patent application, the viscosity is measured with Brookfield CAP 1000+/CAP 2000+ viscometers. These ICI type viscometers with cone-plate viscometer geometry and imposed speed allow rapid measurement, at controlled temperature, on small sample volumes. The characterization is carried out at a high shear rate.

The viscosity of the sample is measured at 25° C. according to the standard ASTM D4287.

Hardness: The hardness of the crosslinked sample is measured at 25° C. according to the standard ASTM D2240 or ISO868.

Elongation at break and breaking strength: These two physical magnitudes of the crosslinked sample are measured at 25° C. according to the standard ASTM D412.

Modulus of elasticity at 100% elongation: This physical magnitude of the sample is measured at 25° C. according to the standard ASTM D412.

Tear strength: This physical magnitude of the sample is measured at 25° C. according to the standard ISO-34-2 from “bean test specimen”.

Tackiness: The tackiness of the sample is measured qualitatively at 25° C. by placing an index finger on the face of the sample to be characterized. Once the index finger has been placed on the face of the sample, pressure is applied with the index finger, and the finger is then withdrawn to evaluate the tackiness or non-tackiness of the face of the sample.

In the examples above, the face of the sample characterized is the last layer of the sample after crosslinking.

### Photocrosslinkable Compositions:

In the context of the examples of the present invention, when it is desired to have a silicone composition that is photocrosslinkable and stable over a long period of time ranging up to several months, it is then possible to add to said composition 10 to 1000 ppm of stabilizer such as 4-methoxyphenol.

### Comparative Photocrosslinkable Composition:

Composition C₁: In the context of the examples below, composition C₁ is formed from photoinitiator C1 present at X % by mass relative to the total mass of the composition. Composition C₁ obtained is mixed for 2 minutes by hand until the solution is clear.

Composition C₂: In the context of the examples below, composition C₂ is formed from photoinitiator C2 present at X % by mass relative to the total mass of the composition. Composition C₂ obtained is mixed for 2 minutes by hand until the solution is clear.

### Photocrosslinkable Compositions According to the Present Invention:

Composition 1: In the context of the examples below, composition 1 is formed from photoinitiator B1 present at X % by mass relative to the total mass of the composition. Composition 1 obtained is mixed for 2 minutes by hand until the solution is clear.

Composition 2: In the context of the examples below, composition 2 is formed from photoinitiator B2 present at X % by mass relative to the total mass of the composition. Composition 2 obtained is mixed for 2 minutes by hand until the solution is clear.

Composition 3: In the context of the examples below, composition 3 is formed from photoinitiator B3 present at X % by mass relative to the total mass of the composition. Composition 3 obtained is mixed for 2 minutes by hand until the solution is clear.

It should be noted that the mass percentage of each photoinitiator noted above X % is specified in each example in the present patent application.

It should be noted that the examples according to the present invention are performed without solvent or co-solvent for dissolving the photocrosslinkable compositions.

In the following examples, composition 1a₁ denotes composition 1 used with polymer a₁ as organopolysiloxane A.

Composition 1a₂ denotes composition 1 used with polymer a₂ as organopolysiloxane A.

In the specific case where a mixture of organopolysiloxanes a₁ and a₃ is present in composition 2, it will then be denoted composition 2a₁+a₃.

Composition C₁a₃ will denote composition C₁ used with polymer a₃ as organopolysiloxane A. By analogy, compositions 1, 2 and 3 will be noted as set out above.

### Materials and Apparatus:

The Asiga Max 3D printer is a (DLP) 3D printer: Before adding to the 1 L tank of the apparatus (with a print volume XYZ: 119×67×75 mm³), the photocrosslinkable compositions were mixed manually or using a mixer. A test specimen with a thickness of 2 mm±0.1 consisting of 27 layers (i.e. 75 μm per layer) was then designed from a computer program. Unless otherwise indicated, in the present patent application the first layer was irradiated for 20 s and the subsequent layers were irradiated for a period of 5 s for each layer at 385 nm and at an energy defined in the examples.

The Anycubic Photon Mono 6K printer is an (LCD) 3D printer: In this case, the light from a set of 405 nm LEDs was projected through an LCD screen which acted as a mask revealing only the pixels required to print the model.

Before adding to the 1 L tank of the apparatus (with a printing volume XYZ 192×120×245 mm³), the photocrosslinkable compositions were mixed manually or using a mixer. A test specimen with a thickness of 2 mm±0.1 consisting of 27 layers (i.e. 75 μm per layer) was then designed from a computer program. Unless otherwise indicated, in the present patent application the first layer was irradiated for 40 s and the subsequent layers were irradiated for a duration of 20 s for each layer at 405 nm and at an energy defined in the examples.

### Example 1: Synthesis of the Photoinitiators B

The various photoinitiators of the present invention were prepared via a preparation process analogous to those disclosed in patent application WO 2014/053455.

### Example 2: Solubility Tests

With a view to evaluating the solubility of the photoinitiators of the present invention, B1, B2 and B3, the photocrosslinkable compositions 1a₁, 1a₂, 2a₁, 2a₂, 3a₁ and 3a₂ were prepared.

In parallel, the comparative photocrosslinkable compositions C₁a₁ and C₂a₂ were also prepared.

These tests were conducted at two different mass percentages. Firstly, the photocrosslinkable compositions (1a₁, 1a₂, 2a₁, 2a₂, 3a₁ and 3a₂) contained 1% by mass of photoinitiator relative to the total mass of the composition. Secondly, the photocrosslinkable compositions (1a₁ and 2a₁) contained 10% by mass of photoinitiator relative to the total mass of the composition.

The solubility of these different photoinitiators was observed visually with the naked eye after manual stirring of the different samples.

The table below indicates the solubility of the various photoinitiators of the present invention.

TABLE 1
Study of solubility of the various photoinitiators

| | Mass percentage of | Solubility of the |
|---|---|---|
| | photoinitiator | photoinitiator |
| | B or C1 relative | in organopolysiloxane |
| | to the mass of | A after |
| Composition | organopolysiloxane A | manual stirring |
| Comparative | 1% | No |
| Composition | 10% | No |
| C₁a₁ | | |
| Invention | 1% | Yes |
| Composition | 10% | Yes |
| 1a₁ | | |
| Invention | 1% | Yes |
| Composition | 10% | Yes |
| 2a₁ | | |
| Comparative | 1% | No |
| Composition | | |
| C₁a₂ | | |
| Invention | 1% | Yes |
| Composition | | |
| 2a₂ | | |
| Invention | 1% | Yes |
| Composition | | |
| 3a₂ | | |

It will be noted that the comparative photocrosslinkable compositions C₁a₁ and C₁a₂ with photoinitiator C1 are hazy at the various mass percentages indicated in the table above.

The insolubility of photoinitiator C1 in the organopolysiloxanes A (a₁ and a₂) makes it difficult to use in additive manufacturing methods such as those described in the present invention. The addition of a solvent may prove to be necessary to dissolve such a system.

Specifically, haze is observed visually from 1% by mass of photoinitiator C1 relative to the weight of organopolysiloxane A. This haze increases when the mass percentage of photoinitiator C1 relative to the total mass of the composition is increased. On the other hand, the photoinitiators B1, B2 and B3 of the present invention have satisfactory solubility in organopolysiloxanes A (a₁ and a₂) at the various mass percentages indicated in the table above.

### Example 3: Study and Characterization of Photocrosslinkable Compositions According to the Present Invention

### Example 3a

TABLE 2
Summary table of the photocrosslinkable compositions used:

| | Mass percentage of | Molar amount of |
|---|---|---|
| | photoinitiator | phosphorus atom |
| | relative to the | present in 100 g of |
| Photocrosslinkable | total mass of the | photocrosslinkable |
| composition | composition (%) | composition (mmol) |
| Comparative composition | 0.7 | 2.2 |
| C₁a₂ | | |
| Composition 2a₂ | 0.7 | 1.0 |

The molar amount of phosphorus atom present in the photocrosslinkable composition allows an approximation to be made of the amount of active agent material in the photocrosslinkable composition studied.

Thus, it is noted that the photocrosslinkable composition of the present invention in Example 3 has a small amount of active agent material relative to the comparative composition C₁a₂.

### Example 3b: Crosslinking Depth of a Photocrosslinkable Composition According to the Process of the Invention

In the context of this example, the organopolysiloxane A used in the various photocrosslinkable compositions is polymer a₂.

This example is directed toward comparing the depth of crosslinking of a photocrosslinkable composition according to the present invention (2a₂) and a comparative photocrosslinkable composition (C₁a₂) as described in Table 2.

TABLE 3
Crosslinking depth measurement (μm)

| | | UV-LED (Asiga Max 3D printer) | |
|---|---|---|---|
| | | at 385 nm | |
| | | 5 mW/ | 11 mW/ |
| | | cm² | cm² |
| Crosslinking | Comparative | — | — |
| depth after | Composition C₁a₂ | | |
| 8 s of | Invention Composition | — | 580 |
| exposure | 2a₂ | | |
| (μm) | | | |
| Crosslinking | Comparative | — | 366 |
| depth after | Composition C₁a₂ | | |
| 10 s of | Invention Composition | — | 840 |
| exposure | 2a₂ | | |
| (μm) | | | |

It is noted that at low light intensity a greater crosslinking depth is obtained with the photocrosslinkable composition 2a₂ of the present invention than with the comparative composition C₁a₂.

Under these conditions, it was observed that at 5 mW/cm², the gel point (a measurable non-liquid thickness) was reached for the photocrosslinkable composition 2a₂ after 12 s, whereas for the comparative photocrosslinkable composition C₁a₂, the gel point did not occur until after 18 s.

### Example 3b: Evaluation of the Mechanical Properties of the Test Specimen Obtained According to the Process of the Invention (without Addition of Filler)

The physical and mechanical properties of the test specimens produced according to the process of the invention from the photocrosslinkable compositions of Example 3a were tested.

These properties were tested at two different energy values, namely 5 mW/cm² and 11 mW/cm².

The 3D printer used is the Asiga Max at 385 nm; the first layer is irradiated for 80 s and each of the other subsequent layers is irradiated for 20 s to obtain a test specimen and to be able to evaluate the mechanical properties.

Table 4 below mentions the mechanical and physical properties such as elongation at break, breaking strength, modulus of elasticity at 100%, hardness and tackiness of the test specimen at various energy values. The mechanical property values indicated are an average of results obtained for measurements taken on four different test specimens printed simultaneously.

TABLE 4
Measurement of the mechanical and physical
properties of the various test specimens

| | | UV-LED (Asiga Max 3D | |
|---|---|---|---|
| | | printer) at 385 nm | |
| | | 5 mW/ | 11 mW/ |
| | | cm² | cm² |
| Elongation | Comparative Composition | 105 ± 40 | 156 ± 42 |
| at break | C₁a₂ | | |
| (%) | Invention Composition 2a₂ | 140 ± 12 | 160 ± 10 |
| Tensile | Comparative Composition | 0.28 ± 0.05 | 0.33 ± 0.08 |
| strength | C₁a₂ | | |
| MPa | Invention Composition 2a₂ | 0.21 ± 0.01 | 0.28 ± 0.05 |
| Modulus | Comparative Composition | 0.28 ± 0.05 | 0.22 ± 0.03 |
| of elastic- | C₁a₂ | | |
| ity at | Invention Composition 2a₂ | 0.14 ± 0.01 | 0.17 ± 0.03 |
| 100% (%) | | | |
| Hardness | Comparative Composition | 8 | 10 |
| (Shore A) | C₁a₂ | | |
| | Invention Composition 2a₂ | 10 | 12 |
| Tackiness | Comparative Composition | Very tacky | Tacky |
| of the | C₁a₂ | | |
| specimen | Invention Composition 2a₂ | Tacky | Non-tacky |

Table 4 above shows that the two test specimens produced according to the method of the invention have satisfactory mechanical properties.

Moreover, the test specimen obtained according to the method of the invention does not have any tackiness, unlike the comparative test specimen C₁a₂. The non-tackiness allows the post-treatment steps prior to subsequent application of the test specimen obtained according to the process of the invention to be limited.

### Example 4: Study and Characterization of a Photocrosslinkable Composition of the Present Invention

### Example 4a

TABLE 5
Summary table of the photocrosslinkable compositions used:

| | Mass percentage of | Molar amount of |
|---|---|---|
| | photoinitiator | phosphorus atom |
| | relative to the | present in 100 g of |
| Photocrosslinkable | total mass of the | photocrosslinkable |
| composition | composition (%) | composition (mmol) |
| Comparative composition | 0.7 | 2.20 |
| C₁a₃ | | |
| Comparative composition | 0.7 | 1.67 |
| C₂a₃ | | |
| Composition 1a₃ | 0.7 | 0.50 |
| Composition 2a₃ | 0.5 | 0.72 |

The molar amount of phosphorus atom present in the photocrosslinkable composition allows an approximation to be made of the amount of active agent material in the photocrosslinkable composition studied.

Thus, it is noted that the photocrosslinkable composition of the present invention in Example 4 has a small amount of active agent material relative to the comparative compositions C₁a₃ and C₂a₃.

### Example 4b: Evaluation of the Crosslinking Depth of Photoinitiators of the Present Invention

In the context of this example, the organopolysiloxane A used in the various photocrosslinkable compositions is polymer a₃. This example is directed toward comparing the depth of crosslinking of photocrosslinkable compositions of the present invention (1a₃ and 2a₃) and of a comparative photocrosslinkable composition (C₁a₂) as described in Table 5.

TABLE 6
Measurement of the crosslinking depth values for the various
compositions as a function of the energy used (5 mW/cm²,
11 mW/cm² or 21 mW/cm²).
UV-LED (Asiga Max 3D printer) at 385 nm

| | | 5 mW/cm² | 11 mW/cm² | 21 mW/cm² |
|---|---|---|---|---|
| Crosslinking | Comparative | — | 550 | 1200 |
| depth after | Composition C₁a₃ | | | |
| 10 s of | Comparative | — | — | — |
| exposure | Composition C₂a₃ | | | |
| (μm) | Invention | — | 150 | 700 |
| | Composition 1a₃ | | | |
| | Invention | — | 320 | 1570 |
| | Composition 2a₃ | | | |

It is then noted that the comparative photocrosslinkable composition C₂a₃ (BAPO) does not lead to any crosslinking.

On the other hand, the photocrosslinkable compositions of the present invention 1a₃ (photoinitiator B1) and 2a₃ (photoinitiator B2) have satisfactory crosslinking depth, as does the comparative composition C₁a₃ (TPO-L).

### Example 4c: Evaluation of the Mechanical Properties of the Test Specimen Obtained by 3D Printing without Addition of Filler

The physical and mechanical properties of the test specimens produced according to the process of the invention from the photocrosslinkable compositions of Example 4a were tested. As a reminder, the photocrosslinkable composition 2a₃ indicated in the table below has a photoinitiator mass percentage of 0.5% by mass relative to the total mass of the composition. The photocrosslinkable compositions 1a₃, C₁a₃ and C₂a₃ contained 0.7% by mass of photoinitiator relative to the total mass of the composition.

The 3D printer used is the Asiga Max at 385 nm; the first layer is irradiated for 80 s and each of the other subsequent layers is irradiated for 20 s to obtain a test specimen and to be able to evaluate the mechanical properties.

In the context of this test, overexposure is deliberately applied so as to obtain total conversion of the acrylates and to evaluate the photoinitiator system beforehand.

UV-LED (Asiga Max 3D printer) at 385 nm

| | | 11 mW/cm² |
|---|---|---|
| Elongation at | Comparative Composition C₁a₃ | 144 ± 40 |
| break (%) | Comparative Composition C₂a₃ | 79 ± 16 |
| | Invention Composition 1a₃ | 105 ± 35 |
| | Invention Composition 2a₃ | 195 ± 60 |
| Tensile | Comparative Composition C₁a₃ | 0.29 ± 0.08 |
| strength | Comparative Composition C₂a₃ | 0.23 ± 0.04 |
| MPa | Invention Composition 1a₃ | 0.21 ± 0.07 |
| | Invention Composition 2a₃ | 0.51 ± 0.03 |
| Modulus of | Comparative Composition C₁a₃ | 0.19 ± 0.01 |
| elasticity | Comparative Composition C₂ₐ₃ | n.d. since |
| at 100% (%) | | elongation <100% |
| | Invention Composition 1a₃ | 0.21 ± 0.02 |
| | Invention Composition 2a₃ | 0.22 ± 0.03 |
| Hardness | Comparative Composition C₁ₐ₃ | 16 |
| (Shore A) | Comparative Composition C₂a₃ | 8.8 |
| | Invention Composition 1a₃ | 17 |
| | Invention Composition 2a₃ | 17 |
| Tackiness of | Comparative Composition C₁a₃ | Sparingly tacky |
| the specimen | Comparative Composition C₂a₃ | Tacky |
| | Invention Composition 1a₃ | Non-tacky |
| | Invention Composition 2a₃ | Non-tacky |

Table 7 above shows that the comparative photocrosslinkable composition C₂a₃ (BAPO) does not produce a test specimen with satisfactory mechanical properties.

On the other hand, the photocrosslinkable compositions of the present invention 1a₃ (photoinitiator B1) and 2a₃ (photoinitiator B2) afford test specimens with satisfactory mechanical properties, as does the test specimen obtained from the comparative composition C₁a₃ (TPO-L).

It can also be seen that the test specimen obtained according to the process of the invention does not have any tackiness, unlike the comparative test specimens.

### Example 5: Evaluation of Crosslinking Depth of Photoinitiators of the Present Invention at Very Low Energy at 405 nm (1.5 mW/cm² to 3.8 mW/cm²)

### Example 5a

TABLE 8
Summary table of the photocrosslinkable compositions used:

| | Mass percentage of | Molar amount of |
|---|---|---|
| | photoinitiator | phosphorus atom |
| | relative to the | present in 100 g of |
| Photocrosslinkable | total mass of the | photocrosslinkable |
| composition | composition (%) | composition (mmol) |
| Comparative composition | 1.0 | 2.80 |
| C₁a₃ | | |
| Composition 2a₃ | 1.0 | 1.44 |
| Composition 3a₃ | 1.2 | 1.57 |

The molar amount of phosphorus atom present in the photocrosslinkable composition allows an approximation to be made of the amount of active agent material in the photocrosslinkable composition studied.

Thus, it is noted that the photocrosslinkable composition of the present invention in Example 5 has a small amount of active agent material relative to the comparative composition C₁a₃.

In the context of this example, the organopolysiloxane A used in the various photocrosslinkable compositions is polymer a₃. This example shows the activity of the photoinitiators B2 and B3 defined in the present invention at a wavelength of 405 nm, and thus at very low energy.

The 3D printer used is the UV-LED (Anycubic Photon Mono 6k) at 405 nm; the first layer is irradiated for 80 s and each of the other subsequent layers is irradiated for 20 s to obtain a test specimen.

TABLE 9
Measurement of the crosslinking depth values for the various
compositions as a function of the energy used (1.5 mW/cm²,
2.6 mW/cm² or 3.8 mW/cm²).
UV-LED via LCD screen (Anycubic Photon Mono 6k) at 405 nm

| | | 1.5 mW/ | 2.6 mW/ | 3.8 mW/ |
|---|---|---|---|---|
| | | cm² | cm² | cm² |
| Crosslinking | Comparative | — | 330 | 590 |
| depth after | Composition C₁a₃ | | | |
| 30 s of | Invention | 140 | 340 | 830 |
| exposure | Composition 2a₃ | | | |
| (μm) | Invention | 140 | 400 | 590 |
| | Composition 3a₃ | | | |

These tests clearly demonstrate the activity of the photocrosslinkable compositions of the present invention at very low energy and very low molar concentration of photoinitiator.

### Example 6: Study of the Mechanical Properties of a 3D Printed Test Specimen Formulation with Filler

In the context of this example, the organopolysiloxane A used in the various photocrosslinkable compositions is the combination of polymer a₁ and a₃.

The aim of this example is to measure the mechanical properties of a test specimen according to the process of the invention containing 22% to 30% of filler D1. The formulations prepared under the conditions in Table 10 below were placed in the Asiga 3D printer fitted with a UV-LED with a wavelength of 385 nm.

The test specimens 3D printed in this example according to the formulae set out below were produced at an energy of 11 mW/cm². The 3D test specimen was printed with 27 layers, each 75 microns thick.

TABLE 10
Summary table of the various photocrosslinkable compositions used:

| | Masses and mass percentages of the constituents | | | | | |
|---|---|---|---|---|---|---|
| | of the formulations of the present invention | | | | | |
| | Comparative | Invention | Invention | Invention | Invention | Invention |
| | formulation | formulation | formulation | formulation | formulation | formulation |
| Constituents | with 22% D1 | with 22% D1 | with 22% D1 | with 25% D1 | with 25% D1 | with 30% D1 |
| of the | C₁a₁ + a₃ | 2a₁ + a₃ | 3a₁ + a₃ | 2a₁ + a₃ | 3a₁ + a₃ | 2a₁ + a₃ |
| formulations | mass % | mass % | mass % | mass % | mass % | mass % |
| C1 | 1.1 | — | — | — | — | — |
| B2 | — | 1.1 | — | 1.06 | — | 0.78 |
| B3 | — | — | 1.1 | — | 1.06 | — |
| Polymer a₃ | 65.93 | 65.93 | 65.93 | 63.39 | 63.41 | 61.48 |
| Polymer a₁ | 10.99 | 10.99 | 10.99 | 116 | 116 | 7.78 |
| Filler D1 | 21.98 | 21.98 | 21.98 | 24.99 | 24.97 | 29.96 |
| Total | 100 | 100 | 100 | 100 | 100 | 100 |

The viscosity of the formulations containing 22% to 30% silica shown in the table above were measured according to the protocol described below.

After manual mixing of these formulations for 5 minutes, the viscosities of these formulations were measured after a rest time of at least one hour, using a Brookfield Cap 2000 cone-plate viscometer (cone 6) as mentioned in Table 11 below.

TABLE 11
Measurement of the viscosity of the various formulations produced:

| | | Shear rate s⁻¹ | | | | |
|---|---|---|---|---|---|---|
| | | 17 | 33 | 66 | 100 | 133 |
| Viscosity of the | Comparative | 19 932 | 13 233 | 10 461 | 9020 | 8250 |
| compositions comprising | Formulation | | | | | |
| 22% silica (mPa · s) | C₁a₁ + a₃ | | | | | |
| | Invention | 6113 | 5775 | 5313 | 5082 | 4942 |
| | Formulation | | | | | |
| | 2a₁ + a₃ | | | | | |
| | Invention | 6402 | 6105 | 5577 | 5280 | 5173 |
| | Formulation | | | | | |
| | 3a₁ + a₃ | | | | | |
| Viscosity of the | Invention | 8052 | 7722 | 7408 | 7348 | 7285 |
| compositions comprising | Formulation | | | | | |
| 25% silica (mPa · s) | 2a₁ + a₃ | | | | | |
| | Invention | 7854 | 6996 | 6913 | 6862 | 6848 |
| | Formulation | | | | | |
| | 3a₁ + a₃ | | | | | |
| Viscosity of the formulation | Invention | 12 408 | 11 154 | 11 434 | 11 708 | 11 656 |
| comprising 30% silica | Formulation | | | | | |
| (mPa · s) | 2a₁ + a₃ | | | | | |

The comparative formulation C₁a₁+a₃ comprising 22% to 30% filler D1 has a high viscosity at low shear rate (<20 s⁻¹) and makes it impossible to produce a test specimen by 3D printing under these conditions. Specifically, the maximum viscosity accepted by the Asiga-DLP printer is 15 000 mPa·s with a special tank supplied by the manufacturer (SG-Max-Tray-1L-LF) suitable for low shear force for high viscosities at low shear rate <20 s⁻¹.

This unsuitability also applies to other additive manufacture techniques such as laser stereolithography (SLA) printing or continuous liquid interface production printing (CLIP) or printing through a liquid crystal display (LCD) screen.

On the other hand, the formulations of the present invention, 2a₁+a₃ and 3a₁+a₃, comprising the photoinitiators B2 and B3 are compatible with making a test specimen by 3D printing at high filler values such as 25% or even 30% by mass of filler D1 relative to the total mass of the formulation.

The table below mentions the mechanical and physical properties such as elongation at break, breaking strength, modulus of elasticity at 100%, hardness and tackiness of the test specimen produced from a test specimen comprising 22%, 25% or 30% of filler D1 at an energy of 11 mW/cm².

TABLE 12
Table of mechanical properties associated with these formulations:

| | UV-LED (Asiga Max 3D printer) at 385 nm (11 mW/cm²) | | | | | |
|---|---|---|---|---|---|---|
| | Formulations with 22% | | | Formulations with 25% | | Formulation with 30% |
| | fumed silica treated | | | fumed silica treated | | fumed silica treated |
| | at 200 m²/g | | | at 200 m²/g | | at 200 m²/g |
| | Comparative | Invention | Invention | Invention | Invention | Invention |
| | Formulation | Formulation | Formulation | Formulation | Formulation | Formulation |
| | C₁a₁ + a₃ | 2a₁ + a₃ | 3a₁ + a₃ | 2a₁ + a₃ | 3a₁ + a₃ | 2a₁ + a₃ |
| Elongation | N.A. | 248 ± 5 | 243 ± 5 | 213 ± 30 | 226 ± 12 | 156 ± 30 |
| at break (%) | | | | | | |
| Tensile | N.A. | 3.4 ± 0.2 | 2.4 ± 2 | 2.87 ± 0.2 | 3.20 ± 0.18 | 1.86 ± 0.6 |
| strength MPa | | | | | | |
| Modulus of | N.A. | 0.72 ± 0.1 | 0.56 ± 0.1 | 0.83 ± 0.08 | 0.82 ± 0.08 | 0.96 ± 0.15 |
| elasticity | | | | | | |
| at 100% (%) | | | | | | |
| Hardness | N.A. | 35 | 35 | 35 | 35 | 36 |
| (Shore A) | | | | | | |
| Tear | N.A. | 2.55 ± 0.04 | not | 3.53 ± 0.03 | 3.25 ± 0.05 | 19.3 ± 0.1 |
| strength (N/m) | | | determined | | | |
| Tackiness of | N.A. | Non-tacky | Non-tacky | Non-tacky | Non-tacky | Non-tacky |
| the specimen | | | | | | |

The abbreviation N.A. mentioned in the table above means that this is not applicable for the comparative test specimen C₁a₁+a₃. Specifically, the high viscosity of the comparative formulation 0a₁+a₃ does not allow additive test specimen manufacture to be performed.

On the contrary, the formulations defined according to the process of the invention allow the production of 3D printed test specimens with satisfactory mechanical properties, as shown by the data in Table 12 above.

Moreover, it can be seen that the presence of filler allows the mechanical and physical properties of the test specimens obtained according to the process of the invention to be considerably improved.

In particular, it can be seen that from 30% of filler D1, the specimen obtained according to the process of the invention has improved tear strength properties relative to the other specimens.

This mechanical property is sufficient to allow new fields of application to be envisaged for this formulation and the 3D printing of functional objects obtained according to the process of the invention.

To finish, it can also be seen that the test specimens obtained according to the process of the invention do not have any tackiness, unlike the comparative test specimens.

### Example 7: Study of the Mechanical Properties of a 3D Printed Tensile Test Specimen Formulation with Filler at Very Low Energy (405 nm)

In the context of this example, the formulation 2a₁+a₃ (containing 30% of filler D1) defined in Table 7 was studied at 3.8 mW/cm². This example is intended to demonstrate that, at a wavelength of 405 nm, the process according to the invention is capable of providing test specimens having satisfactory mechanical properties.

In the context of this example, the first layer of the test specimen was irradiated for 20 s and the subsequent layers were irradiated for 5 s each, at a wavelength of 405 nm and an energy of 3.8 mW/cm².

The table below indicates the mechanical properties of the test specimen obtained according to the process of the invention at an energy of 3.8 mW/cm².

TABLE 13
Mechanical properties of the test specimen obtained according to
the process of the invention at an energy of 3.8 mW/cm²
UV-LED via LCD screen (Anycubic Photon Mono 6k)
at 405 nm and 3.8 mW/cm²

| | Invention |
|---|---|
| | Formulation 2a₁ ± a₃ (30%) |
| Elongation at break (%) | 212 ± 46 |
| Tensile strength MPa | 3.07 ± 0.84 |
| Modulus of elasticity at 100% (%) | 1.04 ± 0.11 |
| Hardness (Shore A) | 39 |
| Tackiness of the specimen | Non-tacky |

As a reminder, the comparative formulation C₁a₁+a₃ with 30% of filler D1 has a high viscosity and does not allow additive manufacture of test specimens.

On the other hand, it can be concluded that at 3.8 mW/cm² and with a high filler D1 value (30%), the mechanical properties of the test specimen obtained according to the process of the invention are satisfactory.

### Example 8: Measurement of the “Yellowing” Effect of a Test Specimen Obtained According to the Process of the Invention

TABLE 14
Measurement of the “yellowing” effect of a test specimen
obtained according to the process of the present invention

| | | UV-LED (Asiga Max 3D printer) at 385 nm | | |
|---|---|---|---|---|
| | | 5 mW/ | 11 mW/ | 21 mW/ |
| | | cm² | cm² | cm² |
| L* | Comparative | 94.04 | 93.16 | not |
| | Composition | | | determined |
| | C₁a₂ | | | |
| | Invention | 94.34 | 94.29 | 94.79 |
| | Composition 2a₂ | | | |
| a | Comparative | 3.40 | 3.65 | not |
| | Composition | | | determined |
| | C₁a₂ | | | |
| | Invention | 3.60 | 3.51 | 4.07 |
| | Composition 2a₂ | | | |
| b | Comparative | 2.08 | 0.89 | not |
| | Composition | | | determined |
| | C₁a₂ | | | |
| | Invention | 1.06 | 1.47 | −0.21 |
| | Composition 2a₂ | | | |

The various photocrosslinkable compositions mentioned in the table above have a photoinitiator mass percentage of 1% relative to the total mass of the photocrosslinkable composition. In the context of this example, the “yellowing” effect of a test specimen obtained according to the process of the invention is studied. The test specimen obtained according to the process of the invention is compared with a test specimen obtained from the comparative photocrosslinkable composition C₁a₂, which has satisfactory “photobleaching” properties.

To do this, a CIELAB standard test is performed to evaluate the “yellowing” effect of these various test specimens.

The table above mentions the values for the magnitudes L, a and b of the various test specimens obtained from the photocrosslinkable compositions.

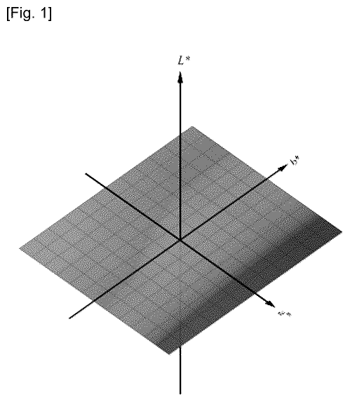

These values correspond to the various axes XYZ shown in FIG. 1 in the appendix.

Thus, it can be seen that the test specimen obtained from the photocrosslinkable composition 2a₂, according to the process of the invention, has L, a and b magnitudes similar to those of the comparative photocrosslinkable composition C₁a₂.

It may thus be concluded that the photocrosslinkable composition 2a₂ of the invention has satisfactory “photobleaching” properties.

### Example 9: Tests on Supports Coated with Silicone Release Coatings

In this example, the photocrosslinkable composition Inv₁ is formed from a mixture of polymer a₄ and a polymer as and 0.8% by mass of photoinitiator B3 relative to the total mass of the photocrosslinkable composition in the rest of the examples.

Similarly a comparative composition Comp₁ consisting of a mixture of polymer a₄ and polymer a₅ and 0.8% by mass of photoinitiator C₁ relative to the total mass of the photocrosslinkable composition.

These two abovementioned compositions were tested at 11.5 mW/cm².

Tests Performed on Supports Coated with Silicone Release Coatings:

Smear: Qualitative control of surface polymerization using the finger trace method, which consists in:
placing the sample of silicone-coated support to be tested on a flat, rigid surface;
making a trace with the tip of a finger, pressing moderately but firmly; and
examining the trace thus made by eye, preferably under oblique light. The presence of a mark, even a very slight one, may thus be seen by the difference in the sheen of the surface.

The assessment is qualitative. The “Smear” is quantified using the following notations:
A: very good, no finger trace
B: slightly poorer, sparingly visible trace
C: clear trace
D: very clear trace and oily appearance of the surface, barely polymerized product, i.e. a grade from A to D, from best to worst result.

Rub-off: Checking the ability of the silicone to adhere to the flexible support by rubbing back and forth with a finger, which consists in:
placing the sample of silicone-coated support to be tested on a flat, rigid surface, with the silicone on the upper surface.
making 10 back and forth (B-F) strokes with the tip of the finger (over a length of about 10 cm), pressing moderately but firmly.
examining the appearance of the rub-off by eye. The rub-off corresponds to the appearance of a fine white powder or small pellets rolling under the finger.

The assessment is qualitative. The rub-off is quantified using the following notations:
10: very good, no appearance of rub-off after 10 B-F strokes.
1: very poor, rub-off as early as the first outward stroke

The score corresponds to the number of round trips (from 1 to 10) after which rub-off is seen.

In other words, a score from 1 to 10, from the worst to the best result.

Dewetting: Assessment of the degree of polymerization of the silicone layer by evaluating the transfer of silicone onto an adhesive placed in contact with the coating using a standard surface tension ink. The method is as follows:
Select a sample of about 20×5 cm of the silicone-coated paper to be characterized, taken in the running direction (machine direction).
Cut a ≈15 cm length of adhesive tape, and then place it adhesive side down on the paper to be tested, without wrinkles, exerting pressure 10 times by sliding a finger along the length of the adhesive tape. (3 M “Scotch” adhesive tape, reference 610, width: 25 mm).
Remove the adhesive tape and lay it flat, with the adhesive part facing upward.
Using a disposable cotton bud, apply a trace of ink over a length of about 10 cm to the adhesive part of the tape (Sherman or Ferrarini & Benelli inks with a surface tension of ˜30 dynes/cm and a viscosity of 2 to 4 mPa/s). Start the timer immediately.
It is considered that the dewetting phase has commenced when the ink line changes appearance: stop the timer.
The ink should be applied to the adhesive part of the tape within 2 minutes of the silicone coating.
If the result obtained is <10 seconds, it is considered that there is migration of silicone onto the adhesive, and that polymerization is incomplete.
A score from 0 to 10 is given corresponding to the time elapsed in seconds before dewetting is observed.
If the result obtained is 10 seconds, the polymerization is considered to be complete. In this case, a score of 10 is given to indicate that the result is very good.
Record the score obtained and the ink used (name, brand, surface tension, viscosity).

Extractables: Measure of the amount of silicone that is not grafted to the network formed during polymerization. These silicones are extracted from the film by immersing the sample in MIBK for at least 24 h as soon as it leaves the machine. This is measured by flame absorption spectroscopy. The extractables content must be kept below 8% and preferably below 6%. The results of the various trade tests are shown in the following table.

TABLE 15
Results of the trade test on the coatings

| Formulation | Comp₁ | Inv₁ |
|---|---|---|
| Deposit (g/m²) (0.85 ± 0.05) | 0.83 | 0.88 |
| Smear | A | A |
| Rub-off | 10 | 10 |
| Dewetting | 10 | 10 |
| In-Line Extractables (100 cm²) % | 5.8 | 5.2 |

The trade tests of the formulation comprising the photoinitiator B3 of the present invention are satisfactory. There is no degradation in the properties of the coating obtained.

Release: Peel force measurements were taken with the standard TESA 7475 adhesive on the silicone-coated support. Test specimens of the multilayer article (adhesive in contact with silicone surface) were stored for 1 day at 23° C. (FINAT 3-FTM 3), 1 day at 70° C. (FINAT 10-FTM 10) or 7 days at 40° C. under the required pressure conditions, and then tested at low peeling speed according to the tests mentioned above and known to those skilled in the art. The peel force is expressed in cN/inch and is measured using a dynamometer, after pressurizing the samples either at room temperature (23° C.) or at a higher temperature for accelerated aging tests.

The results are given in Table 16 below.

TABLE 16
Peel force in cN/inch

| Formulation | Comp1 | Inv1 |
|---|---|---|
| FTM3 | 11.2 | 12.2 |
| FTM10 | 12.7 | 13.0 |
| 7 d @ 40° C. | 11.6 | 11.8 |

It is noted that the peel forces obtained with the formulation of the present invention are satisfactory, notably after aging.

Subsequent adhesion (“SubAd” in the tables): Measurement to verify the conservation of adhesiveness of adhesives (TESA 7475) which have been in contact with the silicone coating according to the FINAT 11 (FTM 11) test known to those skilled in the art. Here, the reference test specimen is PET and the adhesives remained in contact with the silicone surface to be tested for 7 days at 40° C.

The results are expressed as a percentage of conservation of the adhesive strength of the reference tape: CA=(Fm2/Fm1)×100 in % with:
Fm2=Average tape peel force after contact with siliconized support for 20 hours; and
Fm1=Average tape peel force without contact with siliconized support.

The results are collated in Table 17 below.

TABLE 17
Subsequent adhesion (%)

| Formulation | Comp₁ | Inv₁ |
|---|---|---|
| 7 d @ 40° C. | 100 | 100 |

Thus, with the formulation of the present invention, the subsequent adhesion measurement is very satisfactory even after aging. Specifically, there is no loss of adhesiveness of the adhesive placed in contact with the silicone coating.

1. An additive manufacturing method for producing a silicone elastomer article, said method comprising the following steps:
i) using a photocrosslinkable silicone composition X and an irradiation source, said photocrosslinkable silicone composition X comprising:
a) at least one organopolysiloxane A including at least one (meth)acrylate group
b) at least one radical photoinitiator B represented by the formula (I): 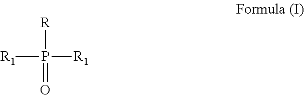
wherein:
R represents a linear or branched C₁-C₅₀ alkylene or heteroalkylene group, optionally a linear or branched C₁-C₁₈ alkylene or heteroalkylene group, said alkylene and heteroalkylene groups comprising at least one siloxane function;
R₁ represents a group of formula (II): 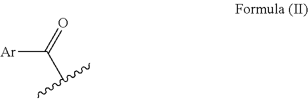
wherein Ar represents an aryl group of 6 to 18 carbon atoms, which is unsubstituted or substituted with at least one of the following groups:
an alkyl group of 1 to 6 carbon atoms,
an alkenyl group of 2 to 4 carbon atoms,
a heteroatom O, N or S,
a halogen,
an SiMe₃ group,
a hydroxyl group (OH),
a group (O-Alk) where Alk represents an alkyl group comprising from 1 to 15 carbon atoms, optionally from 1 to 12 carbon atoms, optionally from 1 to 10 carbon atoms, optionally from 1 to 5 carbon atoms, optionally CH₃ or C₂H₅;
R₂ represents:
a group R₁,
an aryl group of 6 to 18 carbon atoms, which is unsubstituted or substituted with at least one of the following groups:
an alkyl group of 1 to 6 carbon atoms,
an alkenyl group of 2 to 4 carbon atoms,
a heteroatom O, N or S,
a halogen,
an SiMe₃ group,
a hydroxyl group (OH),
a group (O-Alk) where Alk represents an alkyl group comprising from 1 to 15 carbon atoms, optionally from 1 to 12 carbon atoms, optionally from 1 to 10 carbon atoms, optionally from 1 to 5 carbon atoms, optionally CH₃ or C₂H₅;
ii) selectively irradiating at least a portion of the photocrosslinkable silicone composition X by means of the irradiation source to form a part of the silicone elastomer article; and
iii) repeating step ii) a sufficient number of times to produce the silicone elastomer article.

2. The method as claimed in of claim 1, in which wherein the radical photoinitiator B is a compound of formula (VIII): 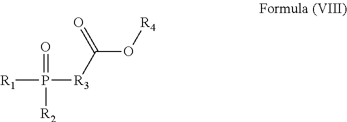
wherein:
R₁ and R₂ represent the groups as defined in claim 1;
R₃ represents a linear or branched C₁-C₆ alkylene or heteroalkylene group;
R₄ represents a linear or branched C₁-C₅₀ alkylene or heteroalkylene group, optionally a linear or branched C₁-C₁₈ alkylene or heteroalkylene group, said R₄ comprising at least one siloxane function.

3. The method of claim 1, wherein the radical photoinitiator Bis a compound of formula (XIII): 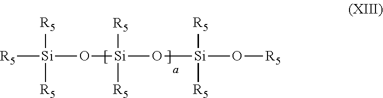
wherein:
R₅, which may be identical or different, represents:
an alkyl group comprising from 1 to 15 carbon atoms, optionally from 1 to 12 carbon atoms, optionally from 1 to 10 carbon atoms, optionally from 1 to 5 carbon atoms, optionally methyl,
an aryl group comprising from 6 to 10 carbon atoms, optionally phenyl,
an alkenyl group comprising from 2 to 6 carbon atoms, optionally vinyl,
an acrylate or meth (acrylate) group,
a hydroxyl group (OH),
a group (O-Alk) where Alk represents an alkyl group comprising from 1 to 15 carbon atoms, optionally from 1 to 12 carbon atoms, optionally from 1 to 10 carbon atoms, optionally from 1 to 5 carbon atoms, optionally CH₃ or C₂H₅,
a group (O-Alk)ₓ with Alk representing an alkyl group comprising from 1 to 15 carbon atoms, optionally from 1 to 12 carbon atoms, optionally from 1 to 10 carbon atoms, optionally from 1 to 5 carbon atoms, optionally methyl, and x represents an integer between 2 and 200,
a linear or branched alkyl group comprising from 1 to 10 carbon atoms, optionally from 1 to 5 carbon atoms, substituted with at least one fluorine atom, optionally from 1 to 10 fluorine atoms, optionally (C₁-C₅)alkyl-CF₃, the alkyl being linear or branched,
a hydrogen atom,
a group of formula (XIV): 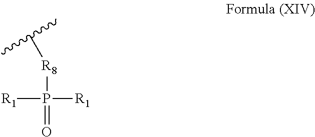
wherein R₁ and R₂ represent groups as defined in claim 1;
R₆ represents a linear or branched C₁-C₅₀ alkylene or heteroalkylene group, optionally a linear or branched C₁-C₁₈ alkylene or heteroalkylene group;
a represents an integer between 0 and 100;
said method being characterized in that at least one group R₅ is represented by the group of formula (XIV).

4. The method of claim 1, wherein the radical photoinitiator B is a compound of formula (XV): 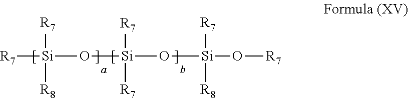
wherein:
R₇, which may be identical or different, represents:
an alkyl group comprising from 1 to 15 carbon atoms, optionally from 1 to 12 carbon atoms, optionally from 1 to 10 carbon atoms, optionally from 1 to 5 carbon atoms, optionally methyl,
an aryl group comprising from 6 to 10 carbon atoms, optionally phenyl;
an alkenyl group comprising from 2 to 6 carbon atoms, optionally vinyl;
a hydroxyl group (OH),
a group (O-Alk) where Alk represents an alkyl group comprising from 1 to 15 carbon atoms, optionally from 1 to 12 carbon atoms, optionally from 1 to 10 carbon atoms, optionally from 1 to 5 carbon atoms, optionally CH₃ or C₂H₅,
a group (O-Alk)ₓ with Alk representing an alkyl group comprising from 1 to 15 carbon atoms, optionally from 1 to 12 carbon atoms, optionally from 1 to 10 carbon atoms, optionally from 1 to 5 carbon atoms, optionally methyl, and x represents an integer between 2 and 200,
an acrylate or meth (acrylate) group,
a linear or branched alkyl group comprising from 1 to 10 carbon atoms, optionally from 1 to 5 carbon atoms, substituted with at least one fluorine atom, optionally from 1 to 10 fluorine atoms, optionally (C₁-C₅)alkyl-CF₃, the alkyl being linear or branched,
a hydrogen atom;
R₈ represents a group as defined for R₇ or a group of formula (XVI): 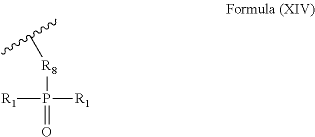
wherein R₁ and R₂ represent groups as defined in claim 1;
R₆ represents a linear or branched C₁-C₅₀ alkylene or heteroalkylene group, optionally a linear or branched C₁-C₁₈ alkylene or heteroalkylene group;
a represents an integer between 0 and 10;
b represents an integer between 1 and 100;
said method being characterized in that at least one group R₈ is represented by the group of formula (XVI).

5. The method of claim 1, wherein the radical photoinitiator B is a compound of formula (XVII): 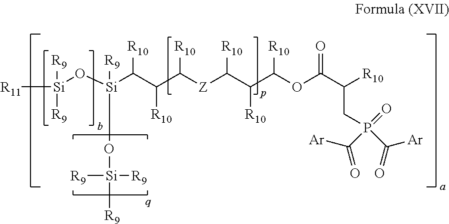
in which wherein:
R₉, which may be identical or different, represents:
an alkyl group comprising from 1 to 15 carbon atoms, optionally from 1 to 12 carbon atoms, optionally from 1 to 10 carbon atoms, optionally from 1 to 5 carbon atoms, optionally methyl,
an aryl group comprising from 6 to 10 carbon atoms, optionally phenyl;
an alkenyl group comprising from 2 to 6 carbon atoms, optionally vinyl;
a hydroxyl group (OH),
a group (O-Alk) where Alk represents an alkyl group comprising from 1 to 15 carbon atoms, optionally from 1 to 12 carbon atoms, optionally from 1 to 10 carbon atoms, optionally from 1 to 5 carbon atoms, optionally CH₃ or C₂H₅,
a group (O-Alk)ₓ with Alk representing an alkyl group comprising from 1 to 15 carbon atoms, optionally from 1 to 12 carbon atoms, optionally from 1 to 10 carbon atoms, optionally from 1 to 5 carbon atoms, optionally methyl, and x represents an integer between 2 and 200,
an acrylate or meth (acrylate) group,
a linear or branched alkyl group comprising from 1 to 10 carbon atoms, optionally from 1 to 5 carbon atoms, substituted with at least one fluorine atom, optionally 1 to 10 fluorine atoms, optionally (C₁-C₅)alkyl-CF₃, the alkyl being linear or branched,
an amino group chosen from (Alk)-NH₂ or (Alk)-NH-(Alk)-NH₂, with Alk representing an alkyl comprising from 1 to 5 carbon atoms,
a carbonyl or carboxyl group,
a hydrogen atom,
a group of formula (XVIII): 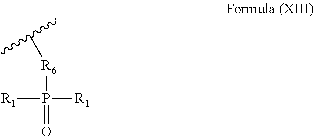
wherein R₁ and R₂ represent groups as defined in claim 1;
R₆ represents a linear or branched C₁-C₅₀ alkylene or heteroalkylene group, optionally a linear or branched C₁-C₁₈ alkylene or heteroalkylene group;
R₁₀, which may be identical or different, represents:
an alkyl group comprising from 1 to 15 carbon atoms, optionally from 1 to 12 carbon atoms, optionally from 1 to 10 carbon atoms, optionally from 1 to 5 carbon atoms, optionally methyl,
an aryl group comprising from 6 to 10 carbon atoms, optionally phenyl;
an alkenyl group comprising from 2 to 6 carbon atoms, optionally vinyl;
a hydroxyl group (OH),
a group (O-Alk) where Alk represents an alkyl group comprising from 1 to 15 carbon atoms, optionally from 1 to 12 carbon atoms, optionally from 1 to 10 carbon atoms, optionally from 1 to 5 carbon atoms, optionally CH₃ or C₂H₅,
a group (O-Alk)ₓ with Alk representing an alkyl group comprising from 1 to 15 carbon atoms, optionally from 1 to 12 carbon atoms, optionally from 1 to 10 carbon atoms, optionally from 1 to 5 carbon atoms, optionally methyl, and x represents an integer between 2 and 200,
an acrylate or meth (acrylate) group,
a linear or branched alkyl group comprising from 1 to 10 carbon atoms,
optionally from 1 to 5 carbon atoms, substituted with at least one fluorine atom,
optionally 1 to 10 fluorine atoms, optionally (C₁-C₅)alkyl-CF₃, the alkyl being linear or branched,
an amino group chosen from (Alk)-NH₂ or (Alk)-NH-(Alk)-NH₂, with Alk representing an alkyl comprising from 1 to 5 carbon atoms,
a carbonyl or carboxyl group,
a hydrogen atom,
R₁₁ represents a —CH₃ group or an oxygen atom;
Z represents a —CH₂— group or an oxygen atom;
Ar represents an aryl group of 6 to 18 carbon atoms which may or may not be substituted with at least one of the following groups:
an alkyl group of 1 to 6 carbon atoms,
an alkenyl group of 2 to 4 carbon atoms,
a heteroatom O, N or S,
a halogen,
an SiMe₃ group,
a hydroxyl group (OH),
a group (O-Alk) where Alk represents an alkyl group comprising from 1 to 15 carbon atoms, optionally from 1 to 12 carbon atoms, optionally from 1 to 10 carbon atoms, optionally from 1 to 5 carbon atoms, optionally CH₃ or C₂H₅;
m represents a natural integer between 1 and 8;
p represents a natural integer equal to 0 or 1;
q represents a natural integer between 0 and 100;
a represents a natural integer equal to 1 or 2;
b represents a natural integer between 0 and 100.

6. The method of claim 1, wherein the radical photoinitiator B and the organopolysiloxane A are one and the same molecule noted AB.

7. The method of claim 1, wherein the compound AB is a compound of formula (XXa), (XXb), (XXc) or (XXd): 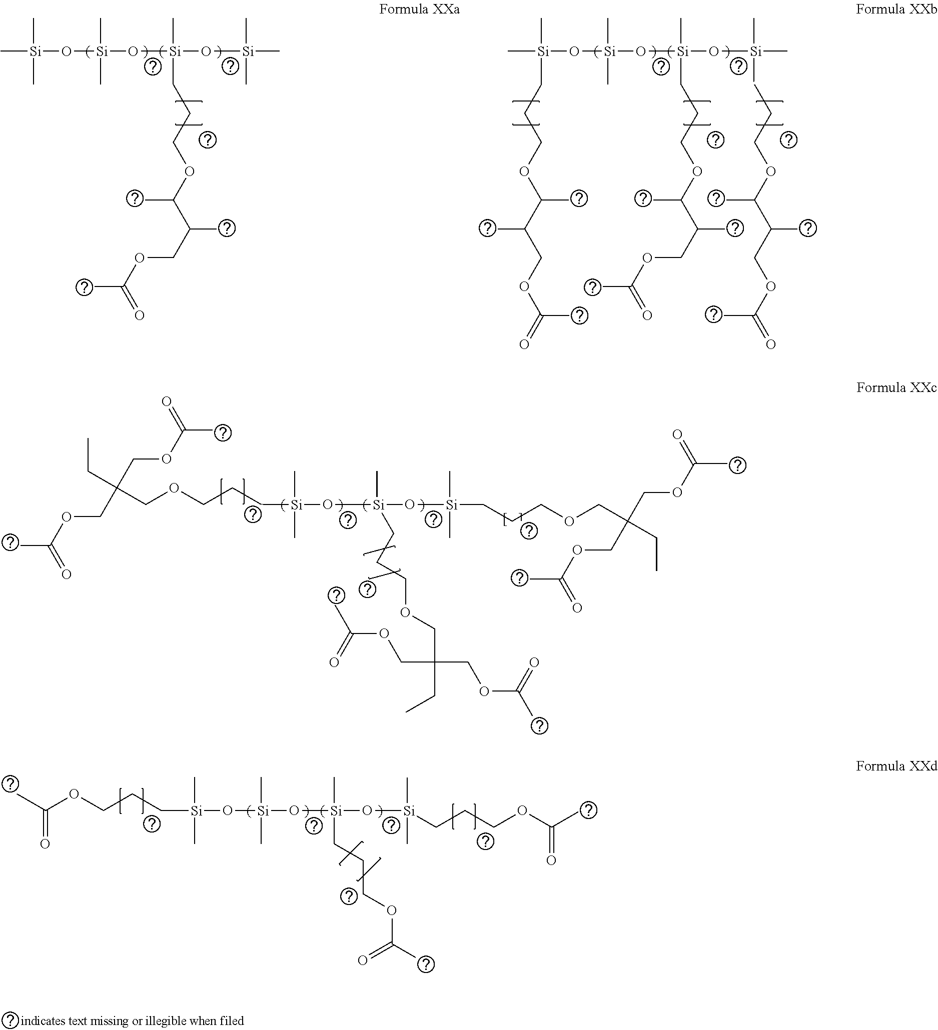
wherein:
R₁₂, which may be identical or different, represents a hydrogen atom or a hydroxyl group;
R₁₃, which may be identical or different, represents:
an alkenyl function of 2 to 4 carbon atoms,
a group of formula (XXI), 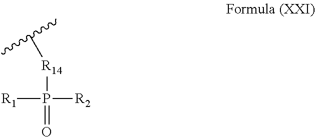
and at least one group R₁₃ represents a group of formula (XXI),
R₁ and R₂ represent the groups as defined in claim 1;
R₁₄ represents:
an alkyl group of 1 to 5 carbon atoms or an alkenyl group of 2 to 5 carbon atoms:
optionally substituted with at least one heteroatom O, N or S,
optionally substituted with at least one alkyl group of 1 to 5 carbon atoms,
optionally substituted with at least one aryl group of 6 to 18 carbon atoms,
x₁ is an integer between 1 and 1000; optionally x₁ is between 1 and 500;
n₁ is an integer between 1 and 100, optionally n₁ is between 2 and 50;
x₂ is an integer between 1 and 1000, optionally x₂ is between 1 and 500;
n₂ is an integer between 0 and 100, optionally n₂ is between 0 and 50;
x₃ is an integer between 1 and 1000, optionally x₃ is between 1 and 500;
n₃ is an integer between 0 and 100, optionally n₃ is between 0 and 50;
x₄ is an integer between 1 and 1000, optionally x₄ is between 1 and 500; and
n₄ is an integer between 0 and 100, optionally n₄ is between 0 and 50;
m₁, m₂, m₃ and m₄ are integers between 1 and 8.

8. The method of claim 1, wherein the photocrosslinkable composition X also comprises a filler D.

9. The method of claim 1, wherein the photocrosslinkable composition X also comprises a photoabsorber E, or a photostabilizer F, and mixtures thereof.

10. The method of claim 1, wherein the weight-average molecular mass of the radical photoinitiator B is between 400 and 10 000 g/mol, optionally between 400 and 5000, optionally between 400 and 3000, optionally between 400 and 2600 g/mol.

11. The method of claim 1, wherein the mass percentage of radical photoinitiator B is between 0.1% and 20% relative to the total mass of the photocrosslinkable composition X, optionally between 0.1% and 5%, optionally between 0.2% and 2%, optionally between 0.4% and 1.5% relative to the total mass of the photocrosslinkable composition X.

12. The method of claim 1, wherein the additive manufacture is a technology chosen from the group consisting of laser stereolithography (LSL) printing, digital light processing (DLP), liquid crystal display (LCD), continuous liquid interface production (CLIP).

13. A photocrosslinkable silicone composition X2 comprising:
from 10% to 99.9% by mass of at least one organopolysiloxane A including at least one (meth)acrylate group;
from 0.1% to 20% by mass of at least one radical photoinitiator B which is a compound of formula (I): 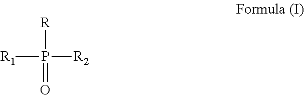
wherein:
R represents a linear or branched C₁-C₅₀ alkylene or heteroalkylene group, optionally a linear or branched C₁-C₁₈ alkylene or heteroalkylene group, said alkylene and heteroalkylene groups comprising at least one siloxane function;
R₁ represents a group of formula (II): 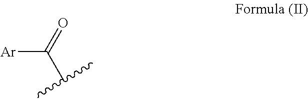
wherein Ar represents an aryl group of 6 to 18 carbon atoms, which is unsubstituted or substituted with at least one of the following groups:
an alkyl group of 1 to 6 carbon atoms,
an alkenyl group of 2 to 4 carbon atoms,
a heteroatom O, N or S,
a halogen,
an SiMe₃ group,
a hydroxyl group (OH),
a group (O-Alk) where Alk represents an alkyl group comprising from 1 to 15 carbon atoms, optionally from 1 to 12 carbon atoms, optionally from 1 to 10 carbon atoms, optionally from 1 to 5 carbon atoms, optionally CH₃ or C₂H₅;
R₂ represents:
a group R₁,
an aryl group of 6 to 18 carbon atoms, which is unsubstituted or substituted with at least one of the following groups:
an alkyl group of 1 to 6 carbon atoms,
an alkenyl group of 2 to 4 carbon atoms,
a heteroatom O, N or S,
a halogen,
an SiMe₃ group,
a hydroxyl group (OH),
a group (O-Alk) where Alk represents an alkyl group comprising from 1 to 15 carbon atoms, optionally from 1 to 12 carbon atoms, optionally from 1 to 10 carbon atoms, optionally from 1 to 5 carbon atoms, optionally CH₃ or C₂H₅.

14. A process for preparing a coating on a support, comprising the following steps:
application of a photocrosslinkable silicone composition X2 to a support, and
crosslinking of said composition by electron or photon irradiation, optionally by exposure to an electron beam, by exposure to gamma rays, or by exposure to radiation with a wavelength of between 200 nm and 450 nm, notably UV radiation.

15. A photoinitiator of formula (XXVIII): 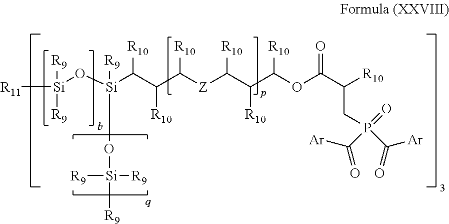
wherein:
R₉, which may be identical or different, represents:
an alkyl group comprising from 1 to 15 carbon atoms, optionally from 1 to 12 carbon atoms, optionally from 1 to 10 carbon atoms, optionally from 1 to 5 carbon atoms, optionally methyl,
an aryl group comprising from 6 to 10 carbon atoms, optionally phenyl;
an alkenyl group comprising from 2 to 6 carbon atoms, optionally vinyl;
a hydroxyl group (OH),
a group (O-Alk) where Alk represents an alkyl group comprising from 1 to 15 carbon atoms, optionally from 1 to 12 carbon atoms, optionally from 1 to 10 carbon atoms, optionally from 1 to 5 carbon atoms, optionally CH₃ or C₂H₅,
a group (O-Alk), with Alk representing an alkyl group comprising from 1 to 15 carbon atoms, optionally from 1 to 12 carbon atoms, optionally from 1 to 10 carbon atoms, optionally from 1 to 5 carbon atoms, optionally methyl, and x represents an integer between 2 and 200,
an acrylate or meth (acrylate) group,
a linear or branched alkyl group comprising from 1 to 10 carbon atoms, optionally from 1 to 5 carbon atoms, substituted with at least one fluorine atom, optionally 1 to 10 fluorine atoms, optionally (C₁-C₅)alkyl-CF₃, the alkyl being linear or branched,
an amino group chosen from (Alk)-NH₂ or (Alk)-NH-(Alk)-NH₂, with Alk representing an alkyl comprising from 1 to 5 carbon atoms,
a carbonyl or carboxyl group,
a hydrogen atom,
a group of formula (XXIX): 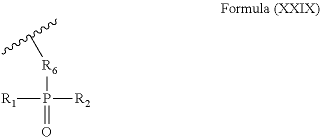
wherein R₁ and R₂ represent groups as defined in claim 1;
R₆ represents a linear or branched C₁-C₅₀ alkylene or heteroalkylene group, optionally a linear or branched C₁-C₁₈ alkylene or heteroalkylene group;
R₁₀, which may be identical or different, represents:
an alkyl group comprising from 1 to 15 carbon atoms, optionally from 1 to 12 carbon atoms, optionally from 1 to 10 carbon atoms, optionally from 1 to 5 carbon atoms, optionally methyl,
an aryl group comprising from 6 to 10 carbon atoms, optionally phenyl;
an alkenyl group comprising from 2 to 6 carbon atoms, optionally vinyl;
a hydroxyl group (OH),
a group (O-Alk) where Alk represents an alkyl group comprising from 1 to 15 carbon atoms, optionally from 1 to 12 carbon atoms, optionally from 1 to 10 carbon atoms, optionally from 1 to 5 carbon atoms, optionally CH₃ or C₂H₅,
a group (O-Alk)ₓ with Alk representing an alkyl group comprising from 1 to 15 carbon atoms, optionally from 1 to 12 carbon atoms, optionally from 1 to 10 carbon atoms, optionally from 1 to 5 carbon atoms, optionally methyl, and x represents an integer between 2 and 200,
an acrylate or meth (acrylate) group,
a linear or branched alkyl group comprising from 1 to 10 carbon atoms, optionally from 1 to 5 carbon atoms, substituted with at least one fluorine atom, optionally 1 to 10 fluorine atoms, optionally (C₁-C₅)alkyl-CF₃, the alkyl being linear or branched,
an amino group chosen from (Alk)-NH₂ or (Alk)-NH-(Alk)-NH₂, with Alk representing an alkyl comprising from 1 to 5 carbon atoms,
a carbonyl or carboxyl group,
a hydrogen atom,
R₁₁ represents a —CH₃ group or an oxygen atom;
Z represents a —CH₂— group or an oxygen atom;
Ar represents an aryl group of 6 to 18 carbon atoms which may or may not be substituted with at least one of the following groups:
an alkyl group of 1 to 6 carbon atoms,
an alkenyl group of 2 to 4 carbon atoms,
a heteroatom O, N or S,
a halogen,
an SiMe₃ group,
a hydroxyl group (OH),
a group (O-Alk) where Alk represents an alkyl group comprising from 1 to 15 carbon atoms, optionally from 1 to 12 carbon atoms, optionally from 1 to 10 carbon atoms, optionally from 1 to 5 carbon atoms, optionally CH₃ or C₂H₅;
m represents a natural integer between 1 and 8;
p represents a natural integer equal to 0 or 1;
q represents a natural integer between 0 and 100;
a represents a natural integer equal to 1 or 2;
b represents a natural integer between 0 and 100;
said photoinitiators being characterized in that when a=1:
q>0 or at least one group R₉ is a hydroxyl group.
